(19) United States
(12) Patent Application Publication
(10) Pub. No.: US 2026/0192703 A1
(43) Pub. Date: Jul. 9, 2026

(54) VEHICLE ENERGY MANAGEMENT SYSTEM

(71) Applicant: Darryll Schneider, Portsmouth, VA (US)

(72) Inventor: Darryll Schneider, Portsmouth, VA (US)

(21) Appl. No.: 19/442,726

(22) Filed: Jan. 7, 2026

Related U.S. Application Data
(60) Provisional application No. 63/743,127, filed on Jan. 8, 2025.

(51) Int. Cl. B60L 58/18; B60L 7/10; B60L 50/40; B60L 50/60; B60L 53/51

(52) U.S. Cl. CPC B60L 58/18; B60L 7/10; B60L 50/40; B60L 50/66; B60L 53/51; B60L 2210/14

(57) ABSTRACT

A vehicle energy management system that integrates onboard energy production and battery management technologies with methods that allow an electric vehicle, plane, or boat to deliver and manage energy production and storage while operating in use. This system for charging and power management can enable an electric vehicle to be capable of charging itself while operating the electric vehicle, capitalizing upon unused wind velocities created via operating the electric vehicle and solar energy contacting the electric vehicle.

### CROSS-REFERENCE TO RELATED APPLICATIONS

This application is a Continuation of, and claims the benefit of, U.S. Provisional Application Ser. No. 63/743,127 filed Jan. 8, 2025.

### TECHNICAL FIELD

This disclosure relates generally to regenerative power assist systems for electric vehicles.

### BACKGROUND OF THE INVENTION

Currently electric vehicles pose significant and hidden greenhouse gas emission contributions from increasing electric vehicle production which increase electricity demands upon fossil fuel generated electrical grids during peak charging conditions. Additionally, electric vehicle charging infrastructures are creating significant bottlenecks in consumer access to meet growing charging demands upon this new public consumption model. Electric vehicles currently include a battery design where a singular primary battery can be charged at supercharging stations, at Stage 2 chargers via 240v devices, or by basic slow charging devices that operate on 120v. In this development model only increasing battery capacity and performance can introduce newer models to higher range deliveries for their vehicles. These growing environmental and charging availability concerns are negatively affecting the electric vehicle market. There is a need for electric vehicles to manage and store energy production more efficiently while simultaneously decreasing the energy requirements that current electric vehicles impose on fossil fuel dependent energy sectors.

### SUMMARY OF THE INVENTION

This vehicle energy management system integrates onboard energy production and battery management technologies with methods that allow an electric vehicle, plane, or boat to deliver and manage energy production and storage while operating in use. This system for charging and power management can enable an electric vehicle to be capable of charging itself while operating the electric vehicle, capitalizing upon unused wind velocities created via operating the electric vehicle and solar energy contacting the electric vehicle.

The first aspect of the invention relates to a vehicle propulsion and energy

management system. In any embodiment, the system can include a plurality of electrical energy storage devices including at least a first propulsion battery and a second propulsion battery; a drive motor configured to deliver propulsion torque to a drivetrain of a vehicle; power conversion circuitry electrically coupled between the plurality of electrical energy storage devices and the drive motor; and a control system configured to selectively assign propulsion duty to one of the first propulsion battery and the second propulsion battery while the other of the first propulsion battery and the second propulsion battery is placed in a non-propulsion role. In any embodiment, the control system can be further configured to route electrical energy between the plurality of electrical energy storage devices through one or more intermediate energy transfer paths so as to condition energy delivery independently of propulsion demand.

In any embodiment, the non-propulsion role can include one or more of charging, balancing, thermal recovery, or rest. In any embodiment, the control system can be configured to alternate propulsion duty between the first propulsion battery and the second propulsion battery during vehicle operation.

In any embodiment, the system can further include an intermediate energy storage device electrically coupled between the plurality of electrical energy storage devices and the drive motor. In any embodiment, the intermediate energy storage device can include a supercapacitor bank. In any embodiment, the control system can be configured to route regenerative braking energy preferentially to the supercapacitor bank prior to transferring energy from the supercapacitor bank to one of the plurality of electrical energy storage devices.

In any embodiment, the system can further include an energy conversion chain. In any embodiment, the energy conversion chain can include a pulsing battery configured to deliver electrical energy in a pulsed manner; a motor configured to convert pulsed electrical energy into mechanical rotational energy; a generator mechanically coupled to the motor and configured to convert mechanical rotational energy into electrical energy; and a voltage conditioning circuit configured to condition electrical output from the generator prior to storage or further use. In any embodiment, the voltage conditioning circuit can be coupled to a charge control unit configured to regulate acceptance of conditioned electrical energy.

In any embodiment, the system can further include a wind energy harvesting subsystem. In any embodiment, the wind energy harvesting subsystem can include a wind input; turbine fins configured to convert kinetic energy of airflow into mechanical energy; a generator mechanically coupled to the turbine fins and configured to convert mechanical energy into electrical energy; and a charge control unit configured to regulate electrical energy produced by the generator. In any embodiment, the system can further include a boost converter disposed between the generator and the charge control unit.

In any embodiment, the system can further include a photovoltaic energy harvesting subsystem configured to generate electrical energy from incident light. In any embodiment, the photovoltaic energy harvesting subsystem can include one or more photovoltaic panels mounted on an exterior surface of the vehicle. In any embodiment, the system can further include a charge control unit electrically coupled between the photovoltaic energy harvesting subsystem and at least one of the plurality of electrical energy storage devices. In any embodiment, the charge control unit can be configured to regulate voltage or current of electrical energy generated by the photovoltaic energy harvesting subsystem prior to delivery to the plurality of electrical energy storage devices. In any embodiment, electrical energy generated by the photovoltaic energy harvesting subsystem can be routed independently of propulsion power delivery. In any embodiment, the control system can be configured to selectively accept or inhibit electrical energy generated by the photovoltaic energy harvesting subsystem based on a system operating condition.

In any embodiment, the control system can be configured to inhibit energy routing operations in response to a safety-critical condition. In any embodiment, the safety-critical condition can include one or more of braking input, traction control intervention, or stability control intervention.

The features disclosed as being part of the first aspect of the invention can be in the first aspect of the invention, either alone or in combination, or follow any arrangement or permutation of any one or more of the described elements. Similarly, any features disclosed as being part of the first aspect of the invention can be in a second or third aspect of the invention described below, either alone or in combination, or follow any arrangement or permutation of any one or more of the described elements.

The second aspect of the invention relates to a method of managing electrical energy in a vehicle. In any embodiment, the method can include selectively assigning propulsion duty to a first propulsion battery while placing a second propulsion battery in a non-propulsion role; delivering electrical energy from the first propulsion battery to a drive motor to propel the vehicle; routing electrical energy through an intermediate energy transfer path independently of propulsion demand; and reassigning propulsion duty between the first propulsion battery and the second propulsion battery during vehicle operation.

In any embodiment, the method can further include routing regenerative braking energy to an intermediate energy storage device prior to charging one of the first propulsion battery and the second propulsion battery.

In any embodiment, the method can further include converting pulsed electrical energy to mechanical energy and reconverting the mechanical energy to conditioned electrical energy prior to storage.

In any embodiment, the method can further include harvesting wind energy using turbine fins and converting the harvested energy to conditioned electrical energy for storage.

In any embodiment, the method can further include harvesting photovoltaic energy from incident light and converting the harvested energy to conditioned electrical energy for storage.

In any embodiment, the method can further include inhibiting energy routing in response to detection of a safety-critical condition.

The features disclosed as being part of the second aspect of the invention can be in the second aspect of the invention, either alone or in combination, or follow any arrangement or permutation of any one or more of the described elements. Similarly, any features disclosed as being part of the second aspect of the invention can be in the first aspect of the invention described above, either alone or in combination, or follow any arrangement or permutation of any one or more of the described elements.

These and other advantages of the invention will be further understood and appreciated by those skilled in the art by reference to the following written specification, claims and appended drawings.

### BRIEF DESCRIPTION OF DRAWINGS

FIG. 1 depicts an electric vehicle with electrical storage and propulsion architecture according to embodiments of the present disclosure.

FIG. 2 depicts an electric vehicle with a drivetrain assembly according to embodiments of the present disclosure.

FIG. 3 depicts an auxiliary harvesting system according to embodiments of the present disclosure.

FIG. 4 depicts an exemplary energy transfer arrangement according to embodiments of the present disclosure.

FIG. 5 depicts a turbine generator subsystem according to embodiments of the present disclosure.

FIG. 6 depicts a photovoltaic energy harvesting subsystem according to embodiments of the present disclosure.

FIG. 7 depicts driver command and motor power distribution architecture according to embodiments of the present disclosure.

FIG. 8 depicts an electric vehicle with an adjustable wind harvesting system.

FIGS. 9A and 9B are schematics depicting a propulsion and energy management architecture according to embodiments of the present disclosure.

### DETAILED DESCRIPTION OF THE PREFERRED EMBODIMENT(S)

It is to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

The present invention relates to a vehicle propulsion system implemented as a multi-reservoir electric propulsion architecture in which propulsion power delivery, energy recovery, buffering, staged charging, and safety governance are coordinated by a centralized electronic control unit (ECU). The system is expressly designed to provide continuous propulsion capability under sustained load conditions while reducing cumulative electrical and thermal stress on primary energy storage components. The architecture further enables selective energy harvesting, external power interaction, and safety-critical override behavior without compromising driver authority or vehicle stability.

Unlike conventional electric vehicle architectures in which a single traction battery pack is tasked with simultaneously supplying propulsion power, absorbing regenerative braking energy, and accepting external charging currents, the disclosed system distributes these functions across multiple electrically distinct energy reservoirs. Each reservoir is optimized for a particular operational role and is electrically coupled to the system through controlled power electronics rather than direct hard connections. This separation allows energy to be captured, staged, conditioned, and delivered according to system state rather than being forced directly into the propulsion battery under transient or high-stress conditions.

In one or more embodiments, the propulsion system includes two propulsion battery packs that are electrically independent of one another and configured to operate under a controlled role-alternation framework. At any given time, one propulsion battery pack is designated by the ECU as an online propulsion pack supplying traction power to one or more drive motors through a high-voltage propulsion bus. The other propulsion battery pack is designated as an offline pack and is electrically isolated from propulsion loads. The offline pack is reserved for controlled charging and recovery, allowing it to accept energy under conditions selected to optimize longevity, thermal behavior, and electrical stability. The ECU dynamically manages the assignment of these roles such that propulsion continuity is maintained while cumulative stress is distributed over time.

The propulsion system further includes a high-power buffer battery that is electrically distinct from the propulsion battery packs and is configured to operate as an intermediate energy staging reservoir. The buffer battery is selected and controlled to accept high instantaneous power levels and to deliver energy in a regulated manner. In operation, the buffer battery absorbs energy originating from sources characterized by transient availability or variable output, such as regenerative braking events, aerodynamic energy harvesting, supercapacitor discharge, and external charging interfaces. By staging energy through the buffer battery, the system prevents high-rate charging currents from being imposed directly on the propulsion battery packs.

A supercapacitor bank is also included as part of the propulsion architecture and is electrically coupled to the propulsion system through controlled power electronics. The supercapacitor bank functions as a rapid-response energy reservoir capable of accepting and delivering energy at rates significantly higher than those tolerated by electrochemical batteries. In certain operating states, the supercapacitor bank supplies an instantaneous propulsion boost by discharging directly into the propulsion bus. In other operating states, the supercapacitor bank discharges in a controlled, pulsed manner into a motor-generator loop, thereby enabling staged charging of the offline propulsion battery pack. The ECU governs the state of charge, availability, and discharge pathways of the supercapacitor bank to ensure that it remains within a usable operating window.

The system further includes a motor-generator subsystem that provides an electromechanical interface between high-power electrical energy and conditioned charging output. In operation, the motor-generator subsystem receives pulsed electrical energy from the supercapacitor bank or buffer battery and converts that energy into a controlled electrical output suitable for delivery to the offline propulsion battery pack. This conversion process allows the ECU to shape current delivery, filter transients, and decouple upstream energy dynamics from battery charging behavior.

In one or more embodiments, the propulsion system further incorporates a turbine generator configured to harvest aerodynamic energy generated during vehicle motion. The turbine generator converts airflow-induced mechanical rotation into electrical energy and is electrically coupled to the propulsion system through power conditioning circuitry and the bidirectional converter network. The turbine generator includes airflow modulation elements whose position is actively controlled by the ECU, thereby allowing the system to regulate turbine speed, harvested power, and aerodynamic drag in real time. Operation of the turbine generator is subordinate to driver safety inputs and vehicle stability conditions.

In one or more embodiments, the propulsion system further incorporates a photovoltaic energy source configured to harvest electrical energy from incident light during vehicle operation or while the vehicle is stationary. The photovoltaic energy source may include one or more photovoltaic panels, coatings, or integrated surfaces disposed on exterior portions of the vehicle and is electrically coupled to the propulsion system through power conditioning circuitry and the bidirectional converter network. Electrical energy generated by the photovoltaic energy source is treated as a supplemental and opportunistic input and is staged through intermediate energy reservoirs under ECU control prior to delivery to propulsion battery packs. Operation of the photovoltaic energy source is subordinate to safety constraints and system operating priorities and does not interfere with propulsion availability, battery conditioning objectives, or driver control authority.

Electrical interconnection among the propulsion battery packs, buffer battery, supercapacitor bank, motor-generator subsystem, turbine generator, photovoltaic harvester, and external electrical interfaces is achieved through a bidirectional DC-DC converter network. This converter network enables controlled, directional transfer of energy between reservoirs and prevents uncontrolled backfeeding or voltage mismatch. The ECU commands each converter module based on system state, thereby enforcing isolation, sequencing, and prioritization of energy flows throughout the propulsion architecture.

The propulsion system further includes one or more external electrical interfaces that enable receipt of energy from external charging sources and, in certain embodiments, delivery of energy to external loads. These interfaces are not directly connected to propulsion battery packs. Instead, externally supplied or exported energy is routed through the converter network and staged through intermediate reservoirs under ECU control. This approach ensures that external interaction does not compromise propulsion readiness or battery health.

Centralized governance of the propulsion system is provided by the ECU, which executes control logic responsible for propulsion battery role assignment, energy routing, boost authorization, turbine generator modulation, and safety enforcement. The ECU is configured to interpret driver inputs as expressions of desired vehicle behavior rather than direct commands to individual energy reservoirs. As a result, the ECU manages the physics of energy flow while preserving intuitive driver control.

The propulsion architecture is expressly designed to enforce a driver-first safety hierarchy. Braking input, traction control intervention, stability control intervention, and other safety-critical signals override propulsion enhancement, energy harvesting, and charging functions. The system does not permit energy optimization objectives to interfere with braking authority or vehicle controllability.

The propulsion system further includes an event data recorder integrated with the ECU and associated sensing infrastructure. The event data recorder continuously monitors propulsion states, energy flows, driver inputs, and control decisions. Operational data is recorded using a rolling buffer architecture and is preserved in response to predefined trigger conditions, enabling forensic analysis, diagnostics, and long-term degradation tracking.

In the disclosed energy management architecture for vehicle propulsion systems, the separation of energy storage, energy conditioning, and propulsion execution is not merely a matter of component placement but constitutes a fundamental organizational principle of the invention. The propulsion system is deliberately structured such that no single energy reservoir is required to simultaneously satisfy incompatible operational demands, such as high-rate discharge for propulsion, high-rate acceptance of regenerative energy, and long-duration energy storage. Instead, the architecture assigns these demands to specialized reservoirs and interposes controlled conversion stages between them, thereby allowing each reservoir to operate within a regime consistent with its physical characteristics.

The propulsion battery packs are thus relieved of direct exposure to the most aggressive transient events encountered during vehicle operation. In particular, regenerative braking events, which may involve rapid and unpredictable energy influx, are prevented from being imposed directly on a propulsion battery pack at uncontrolled rates. Likewise, instantaneous propulsion demands, such as rapid acceleration or torque fill during dynamic maneuvers, are not satisfied by abrupt current draw from a propulsion battery pack alone, but may be supplemented by intermediate energy reservoirs that are better suited to such duty cycles. This structural decoupling is enforced electrically through the bidirectional converter network and logically through ECU control authority.

The turbine generator subsystem is architecturally integrated into the system as a controllable energy source whose operation is subordinate to propulsion and safety objectives. Unlike passive regenerative systems that harvest energy opportunistically without regard to vehicle dynamics, the turbine generator is actively governed by the ECU through airflow modulation. This allows the system to treat aerodynamic energy harvesting as an adjustable parameter rather than a fixed consequence of motion. The turbine generator therefore operates as part of the energy management strategy rather than as a parasitic or uncontrolled device.

Critically, the architecture is designed such that the driver is never placed in the position of managing energy reservoirs directly. The driver's interaction with the system is limited to conventional vehicle controls, and the ECU translates those inputs into propulsion behavior consistent with system constraints. Energy harvesting, buffering, and redistribution occur transparently and are suppressed whenever they would conflict with driver intent or vehicle stability.

For purposes of this specification, the term “energy reservoir” refers to any component or subsystem capable of storing electrical energy for later use, whether through electrochemical, electrostatic, or electromechanical means. In the disclosed architecture, energy reservoirs are intentionally differentiated by function rather than by mere capacity. A “propulsion battery pack” is an energy reservoir optimized for sustained energy delivery over extended durations. A “buffer battery” is an energy reservoir optimized for accepting and releasing energy at higher rates over intermediate durations. A “supercapacitor bank” is an energy reservoir optimized for rapid charge and discharge over very short durations. The motor-generator subsystem, while not an energy reservoir in a static sense, functions as a controllable intermediary that shapes energy transfer between reservoirs. This functional differentiation is central to the system and is preserved regardless of the specific technologies employed.

The term “propulsion battery respiration” is used herein to describe the managed alternation of propulsion battery pack roles between an online propulsion state and an offline conditioning state. “Respiration” does not imply simultaneous discharge and charge of a single pack, nor does it imply periodicity fixed in advance. Rather, “respiration” is a dynamic control strategy in which the ECU determines when a propulsion battery pack should supply propulsion energy and when it should be electrically isolated to allow charging, cooling, or recovery. This framing distinguishes the disclosed system from architectures that merely parallel multiple battery packs or statically partition battery capacity.

The term “online propulsion state” refers to a condition in which a propulsion battery pack is electrically coupled to the propulsion bus and is authorized by the ECU to supply propulsion energy. The term “offline state” refers to a condition in which a propulsion battery pack is electrically isolated from propulsion loads and is not subject to propulsion discharge currents. An offline pack may nevertheless be electrically active within the system for purposes of controlled charging, monitoring, or conditioning. These states are mutually exclusive for a given propulsion battery pack at any moment but are reversible over time.

The term “pulse-conditioned energy transfer” refers to an energy transfer process in which electrical energy is delivered from a source in a pulsed or temporally discrete manner and is subsequently transformed, filtered, rectified, or otherwise conditioned before being delivered to a downstream energy reservoir or load. Pulse-conditioned energy transfer is distinguished from direct pulsed delivery in that the downstream recipient experiences a charging or supply profile that differs in temporal or electrical characteristics from the originating pulses.

The term “hierarchical control logic” refers to a control architecture in which multiple control objectives are organized into ordered priority levels such that higher-priority objectives override or constrain lower-priority objectives. In the disclosed system, hierarchical control logic governs propulsion, safety, energy management, and auxiliary functions, ensuring that safety-critical and driver-intent-related objectives supersede energy optimization or harvesting objectives.

The term “safety-critical veto condition” refers to a detected operating condition or control signal that immediately inhibits, overrides, or terminates one or more energy transfer, harvesting, or propulsion enhancement actions. Safety-critical veto conditions include, without limitation, braking input, traction control intervention, stability control intervention, and other conditions in which continued energy transfer would interfere with vehicle controllability or safety.

The term “energy staging” refers to the temporary capture, storage, or buffering of electrical energy within an intermediate energy reservoir prior to subsequent delivery to another reservoir or load. Energy staging allows energy to be accepted, held, and later redistributed under controlled conditions, thereby decoupling the timing and rate of energy generation from the timing and rate of energy utilization.

The term “transient energy event” refers to a short-duration electrical event characterized by relatively high-power transfer over a limited time interval. Transient energy events include, without limitation, regenerative braking spikes, rapid acceleration demands, propulsion boost events, and electrical transients associated with system state transitions.

The term “event data recording subsystem” refers to a data acquisition and storage subsystem configured to record operational parameters, control decisions, and system state information associated with propulsion and energy management. The event data recording subsystem operates in coordination with the electronic control unit and may preserve recorded data in response to predefined trigger conditions for diagnostic, forensic, or system evaluation purposes.

The term “controlled aerodynamic energy harvesting” refers to the selective conversion of kinetic energy from airflow into electrical energy under explicit authorization and regulation by the electronic control unit. Controlled aerodynamic energy harvesting is distinguished from passive or continuously operating aerodynamic generation in that engagement, output level, and routing of harvested energy are dynamically governed to align with propulsion, safety, and system objectives.

The term “external electrical interface” refers to an electrical connection point configured to exchange electrical energy between the propulsion system and an external electrical source or load. External electrical interfaces may support unidirectional or bidirectional energy transfer and are governed by the electronic control unit to control import, export, staging, and isolation of electrical energy.

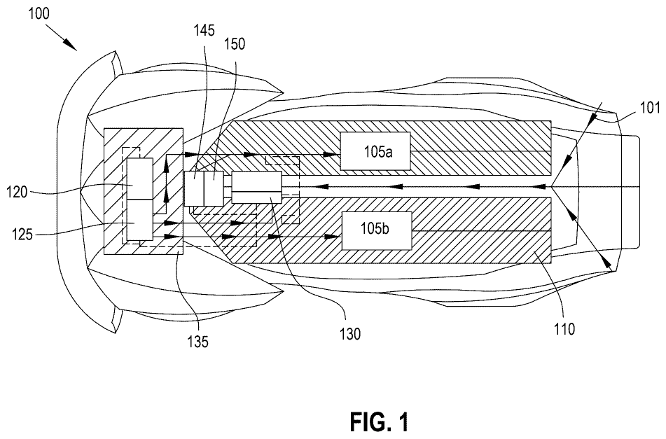

As illustrated in FIG. 1, the energy management architecture is implemented in substantial part through a dual propulsion battery pack respiration architecture in which two propulsion battery packs 105a-b are coordinated by the electronic control unit (ECU) to alternately assume propulsion and conditioning roles. This respiration architecture is not merely a redundancy feature but a foundational operational mechanism by which sustained propulsion capability, controlled charging, and long-term battery health are simultaneously achieved.

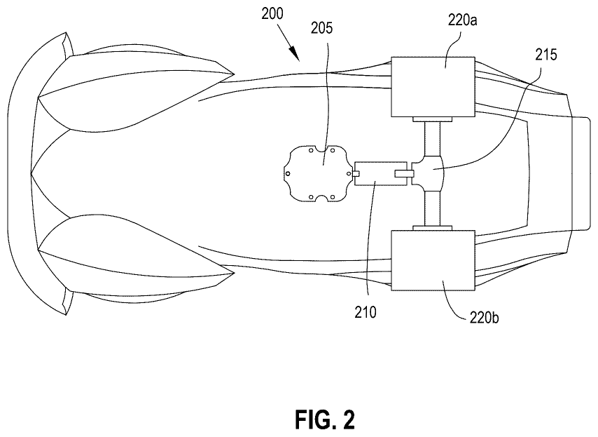

FIG. 1 shows the vehicle 100 including a propulsion architecture in which a first propulsion battery pack 105a and a second propulsion battery pack 105b are arranged longitudinally within the vehicle body. A central energy transfer pathway 101 extends between the propulsion battery packs and toward a rear-mounted propulsion bus 110. Arrows indicate controlled energy flow between components under authorization of an electronic control unit 130. A buffer battery subsystem 145 and a supercapacitor bank 150 are positioned downstream of the propulsion battery packs and upstream of a propulsion motor assembly. The propulsion motor assembly is mechanically coupled to a drivetrain and wheel system, shown in FIG. 2. Additional power conditioning electronics 135 are disposed between the energy reservoirs and the propulsion motor assembly to regulate voltage, current, and pulse-conditioned energy transfer. The illustrated arrangement demonstrates spatial separation of propulsion energy storage, intermediate energy staging, and propulsion delivery components within the vehicle envelope.

In the disclosed system, each propulsion battery pack 105 is configured as a full-capability traction energy source, rather than as a permanently subordinate or auxiliary pack. Each pack 105 is capable of supplying propulsion power to the vehicle under normal operating conditions and is therefore dimensioned and managed as a primary propulsion asset. The respiration architecture does not depend on asymmetric pack sizing, specialized “boost” packs, or sacrificial auxiliary batteries. Instead, the architecture relies on controlled role assignment over time, such that no single propulsion battery pack is continuously exposed to the most demanding operating conditions.

At any given moment during vehicle operation, one propulsion battery pack 105 is designated by the ECU 130 as being in an online propulsion state. In this state, the pack is electrically coupled to the propulsion bus 110 and is authorized to supply traction power to one or more drive motors. The online propulsion pack is subject to discharge currents associated with vehicle acceleration, cruising, hill climbing, and other propulsion demands. Importantly, while the online pack supplies propulsion energy, it is not simultaneously required to absorb regenerative braking energy or accept high-rate charging currents, as those functions are diverted to intermediate reservoirs as further described below.

Concurrently, the other propulsion battery pack is designated as being in an offline state. In the offline state, the pack is electrically isolated from the propulsion bus 110 and is not exposed to propulsion discharge currents. Electrical isolation is achieved through controlled contactors or equivalent switching devices governed by the ECU 130. While isolated from propulsion loads, the offline pack remains actively monitored and may be electrically engaged for the purpose of controlled charging, balancing, thermal conditioning, or diagnostic evaluation. The offline designation therefore does not imply dormancy, but rather a protected operating condition optimized for recovery and preparation.

External energy sources 120 and 125, which may include wind and photovoltaic sources as further described below, are also connected with electrical components 135 that condition the input energy for use by the vehicle 100. Each input energy source 120, 125 may be first received by intermediate energy reservoirs 145, 150 before being used, when conditions allow, to charge the offline propulsion battery 105. The conditioning, routing, and use of the external energy inputs are governed by the ECU.

The ECU 130 maintains awareness of the operational readiness of each propulsion battery pack at all times. This awareness includes, but is not limited to, evaluation of state of charge, temperature distribution, internal resistance trends, recent load history, and fault status. Based on this evaluation, the ECU determines which propulsion battery pack is better suited at a given time to supply propulsion energy and which is better suited to be conditioned in the offline state. This determination is dynamic and may change over the course of vehicle operation.

The respiration architecture is expressly distinguished from systems in which multiple battery packs are simply connected in parallel or series and discharged concurrently. In such conventional arrangements, all packs experience similar stress profiles and age together. In contrast, the disclosed respiration architecture ensures that, over time, each propulsion battery pack experiences alternating periods of high-demand operation and reduced-stress conditioning. This alternating exposure allows thermal recovery, mitigates cumulative degradation, and improves long-term capacity retention.

Transition between online and offline roles is performed as a managed handoff rather than as an abrupt switch. Prior to initiating a role transition, the ECU evaluates whether the currently offline propulsion battery pack is in a condition suitable to assume propulsion duties. This evaluation includes confirmation that the pack has sufficient state of charge, acceptable temperature margins, and no active fault conditions. Only upon satisfying these criteria does the ECU initiate the transition sequence.

During the transition sequence, propulsion continuity is preserved through the use of intermediate energy reservoirs. The supercapacitor bank and, where appropriate, the buffer battery may temporarily support propulsion bus energy while contactors associated with the propulsion battery packs are actuated. This sequencing avoids voltage sag, current spikes, or perceptible interruption of propulsion torque. The transition is therefore transparent to the driver and does not require driver awareness or intervention.

Once the previously offline propulsion battery pack is electrically coupled to the propulsion bus and designated as the new online propulsion pack, the previously online pack is electrically isolated and enters the offline state. At this point, the newly offline pack becomes available for controlled charging and conditioning. Because the offline pack is no longer required to respond to propulsion demands, the ECU is free to impose charging profiles selected for longevity rather than immediacy.

Charging of the offline propulsion battery pack is deliberately decoupled from instantaneous energy availability. Energy destined for the offline pack is staged through the supercapacitor bank, the buffer battery, and, in certain embodiments, the motor-generator subsystem. This staging allows the ECU to regulate charging current, voltage, and timing independent of whether energy originates from regenerative braking, aerodynamic harvesting, or external charging sources. The offline pack is therefore shielded from the abrupt and irregular energy influxes that characterize real-world vehicle operation.

The respiration architecture also enables continuous propulsion operation even during extended driving or endurance scenarios. Because one propulsion battery pack is always available to supply propulsion while the other is being conditioned, the system avoids the forced idle or charging pauses associated with single-pack architectures. This capability is particularly advantageous in applications requiring sustained operation without extended stops.

The ECU further integrates respiration decisions with broader system objectives, including thermal management, degradation mitigation, and anticipated future demand. For example, if the ECU predicts an upcoming period of high propulsion demand, it may prioritize conditioning of a propulsion battery pack to ensure that it is prepared to assume the online role. Conversely, during low-demand operation, the ECU may extend the duration of a pack's offline state to maximize recovery.

Fault tolerance is inherently enhanced by the respiration architecture. In the event that one propulsion battery pack exhibits a fault condition or degraded performance, the ECU may prevent that pack from assuming the online propulsion role while continuing to operate the vehicle using the remaining pack in a reduced or managed performance mode. This selective isolation capability allows continued operation without immediate system shutdown.

At a conceptual level, the respiration architecture redefines the relationship between propulsion and charging. Charging is no longer a distinct operating mode that occurs only when propulsion is inactive. Instead, charging is an ongoing background process applied selectively to the offline propulsion battery pack whenever conditions permit. This reconceptualization allows propulsion and charging to coexist without competing for the same electrical interface.

The timing and sequencing of propulsion battery pack respiration are governed by ECU decision logic that evaluates both instantaneous system state and projected operating conditions. Respiration transitions are therefore neither periodic nor purely reactive. Instead, the ECU considers a combination of present measurements and predictive indicators to determine whether maintaining the current pack assignment or initiating a role transition best serves propulsion continuity, safety, and long-term component health.

In determining whether to initiate a respiration transition, the ECU evaluates the state of charge of each propulsion battery pack in relation to anticipated propulsion demand. Anticipated demand may be inferred from driver inputs, vehicle speed, route characteristics, or learned usage patterns. The ECU further evaluates thermal conditions within each pack, including absolute temperature, temperature gradients across the pack, and rates of temperature change. These thermal considerations allow the ECU to favor a pack that has recovered sufficiently from prior load exposure or to defer a transition if a pack would otherwise be exposed to thermal stress.

Electrical health indicators also influence respiration decisions. The ECU monitors parameters indicative of internal resistance, voltage sag under load, and charge acceptance behavior. Where trends suggest emerging degradation in one pack, the ECU may adjust respiration timing to reduce that pack's exposure to high-demand propulsion states while preserving its availability as a reserve. This adaptive behavior allows degradation to be managed progressively rather than addressed only after fault thresholds are exceeded.

Respiration decisions are further influenced by the availability of staged energy within intermediate reservoirs. When the supercapacitor bank or buffer battery contains sufficient energy to support a smooth transition, the ECU may be more willing to initiate a pack role exchange. Conversely, if intermediate reservoirs are depleted or constrained, the ECU may defer respiration to avoid transient instability. In this manner, respiration timing is coordinated with broader energy management conditions rather than treated as an isolated function.

During normal operation, charging of the offline propulsion battery pack proceeds opportunistically but conservatively. Energy captured from other system sources (wind turbine, photovoltaic components, regenerative braking, etc.) is first absorbed by the supercapacitor bank and buffer battery, as previously described, and is subsequently metered to the offline pack at rates selected to optimize longevity. The ECU may suspend or slow charging of the offline pack during periods of elevated temperature, abnormal voltage behavior, or when upcoming propulsion demands suggest that preserving the offline pack's readiness is preferable to immediate charging.

The respiration architecture also accommodates partial or interrupted charging. The offline propulsion battery pack need not be fully charged before assuming the online role, nor is it required that charging proceed continuously while the pack remains offline. Instead, charging may occur in intervals determined by energy availability, thermal margins, and operational priorities. This flexibility allows the system to integrate respiration seamlessly with real-world driving patterns rather than imposing artificial charging cycles.

From a safety perspective, the respiration architecture includes multiple layers of protection against improper pack engagement. Before closing contactors to place a propulsion battery pack into the online state, the ECU verifies electrical compatibility with the propulsion bus, including voltage alignment and absence of abnormal conditions. If these checks are not satisfied, the transition is aborted or deferred. Similarly, before isolating a pack from the propulsion bus, the ECU ensures that alternative energy sources are available to support propulsion bus stability during the transition interval.

Fault conditions are handled in a manner consistent with the permission-based energy routing model. If a propulsion battery pack exhibits a fault condition that precludes its safe operation in either the online or offline state, the ECU isolates that pack and reconfigures the system to operate using the remaining pack and intermediate reservoirs to the extent safely possible. In such scenarios, propulsion capability may be reduced, but abrupt system shutdown is avoided when feasible.

The respiration architecture further avoids any implication of instantaneous or uncontrolled “hot swapping” of battery packs. At no point are two propulsion battery packs simultaneously required to supply propulsion current, nor are they directly connected to one another. Role transitions are sequenced events governed by explicit authorization and verification steps, ensuring that the system remains within defined electrical and thermal limits throughout the transition.

The respiration architecture further enables background conditioning activities that are not possible in single-pack systems. While a propulsion battery pack is offline, the ECU may perform balancing operations, diagnostic tests, or recalibration procedures that would be impractical under propulsion load. These activities contribute to long-term reliability and performance consistency.

Importantly, the respiration architecture operates seamlessly and automatically from the perspective of the driver. The driver is not required to select which propulsion battery pack is active, nor is the driver notified of respiration transitions under normal conditions. Propulsion behavior remains continuous and predictable, and the complexity of energy management remains confined within the ECU's domain.

Integration with driver-first safety logic is inherent to the respiration architecture. Respiration transitions are subordinate to braking events, traction control intervention, stability control intervention, and other safety-critical conditions. If such conditions arise during a pending or active respiration transition, the ECU may delay, pause, or abort the transition to preserve vehicle controllability and safety. In such cases, the ECU prioritizes maintaining a stable propulsion state over completing a role exchange between propulsion battery packs.

The respiration architecture also interacts with boost authorization logic in a coordinated manner. During periods in which a respiration transition is imminent or underway, the ECU may restrict or inhibit supercapacitor-based propulsion boost to ensure that transient propulsion demands do not coincide with changes in pack coupling. This coordination prevents compound transients that could otherwise stress power electronics or compromise propulsion bus stability.

The ECU is further configured to maintain minimum readiness margins for both propulsion battery packs. Even while a pack is designated as offline, the ECU ensures that it remains within a readiness envelope that would allow it to assume propulsion duties if required. This readiness may include maintaining a minimum state of charge, ensuring acceptable temperature ranges, and preserving electrical isolation integrity. In this manner, the offline pack functions as an active reserve rather than a dormant asset.

The respiration architecture also supports asymmetric operating durations without implying asymmetry of capability. One propulsion battery pack may remain in the online state for longer periods than the other based on usage patterns, thermal recovery needs, or degradation trends. However, this asymmetry arises from control decisions rather than from structural differences between the packs. Over long operational horizons, the ECU may balance cumulative exposure to ensure that neither pack is disproportionately stressed unless system conditions dictate otherwise.

FIG. 2 is a schematic diagram illustrating a rear propulsion drivetrain assembly 200 of a vehicle incorporating the disclosed propulsion system. The diagram depicts a drive motor 205 mechanically coupled to a transfer case 210, which distributes rotational torque to a rear axle assembly 215. The rear axle assembly is mechanically connected to a pair of rear wheels 220a-b, enabling delivery of propulsion torque to the road surface. The illustrated arrangement demonstrates a representative drivetrain configuration in which electrical propulsion power is converted into mechanical rotation at the drive motor and transmitted through drivetrain components to drive the rear wheels. Although shown as a rear-drive configuration, the illustrated drivetrain architecture is exemplary, and alternative embodiments may employ different axle arrangements, drive distributions, or drivetrain layouts while remaining compatible with the disclosed propulsion and energy management system.

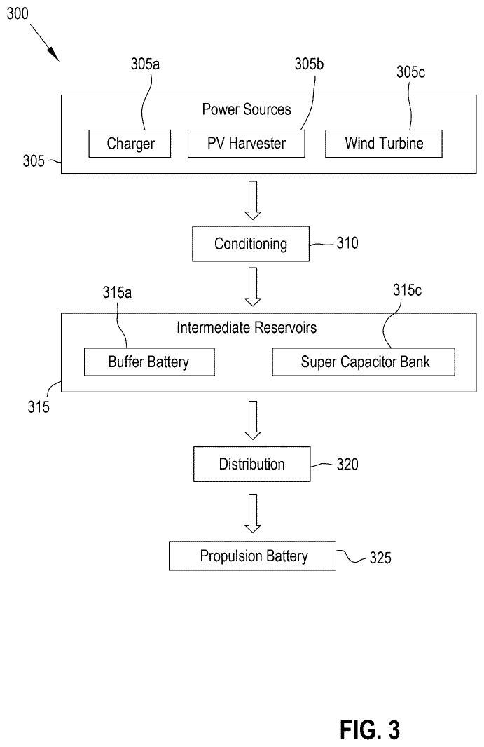

FIG. 3 is a schematic diagram illustrating multiple auxiliary energy harvesting inputs integrated into the propulsion system. The diagram depicts a generator subsystem, a photovoltaic surface or coating, and a wind-driven turbine as distinct electrical energy sources coupled to a charge control module. The charge control module is configured to condition and regulate electrical output from the auxiliary energy sources prior to delivery to downstream energy reservoirs. The illustrated arrangement demonstrates that heterogeneous energy harvesting technologies may be concurrently supported and managed within the system architecture, with electrical energy from each source being selectively accepted, conditioned, and routed under control logic consistent with the broader permission-based energy management framework.

In the illustrated embodiment, an auxiliary energy harvesting system 300 includes a photovoltaic component 305 configured to convert incident light into electrical energy and a wind turbine 310 configured to convert kinetic energy of airflow into electrical energy. The photovoltaic component 305 may comprise one or more photovoltaic panels, coatings, or integrated surfaces disposed on an exterior portion of the vehicle, while the wind turbine 310 may comprise a rotatable turbine element positioned to interact with ambient or ducted airflow during vehicle operation. Electrical output from the photovoltaic component 305 and the wind turbine 310 is electrically coupled to a charge control unit 315, which is configured to receive, condition, and regulate energy from the respective energy sources prior to delivery to downstream energy storage or management components. The charge control unit 315 operates to accommodate variability in energy availability and output characteristics of the photovoltaic component 305 and the wind turbine 310, enabling selective acceptance and controlled routing of harvested energy within the propulsion and energy management system.

Following the charge control unit 315, FIG. 3 further illustrates an energy storage component in the form of a battery 320 electrically coupled to receive conditioned electrical energy from the charge control unit 315. The battery 320 is depicted as an energy storage element configured to store electrical energy generated by the photovoltaic component 305 and the wind turbine 310 for later use. The figure does not require the battery 320 to be a propulsion battery, and the illustrated battery 320 may represent any suitable electrical energy storage device compatible with the charge control unit 315.

The battery 320 is electrically coupled to a control module 325, which is depicted as a functional control element associated with management of electrical energy stored in or delivered from the battery 320. The control module 325 is shown schematically and represents circuitry, logic, or control functionality configured to monitor, regulate, or authorize transfer of electrical energy associated with the battery 320. The control module 325 may operate in coordination with the charge control unit 315, as illustrated, without implying a particular control hierarchy or algorithmic implementation.

Electrical energy managed by the control module 325 is shown as being delivered to an electrical distribution system 330. The electrical distribution system 330 represents conductors, buses, wiring assemblies, or distribution nodes configured to route electrical energy from the battery 320 to one or more downstream electrical loads or subsystems of the vehicle. The distribution system 330 is depicted schematically and may include branching paths or connection points, as illustrated, without limiting the manner in which electrical energy is ultimately consumed.

As shown in FIG. 3, the photovoltaic component 305, wind turbine 310, charge control unit 315, battery 320, control module 325, and electrical distribution system 330 together form an auxiliary energy harvesting and distribution arrangement. This arrangement enables electrical energy generated from environmental sources to be conditioned, stored, managed, and distributed within the vehicle electrical system independently of primary propulsion energy generation.

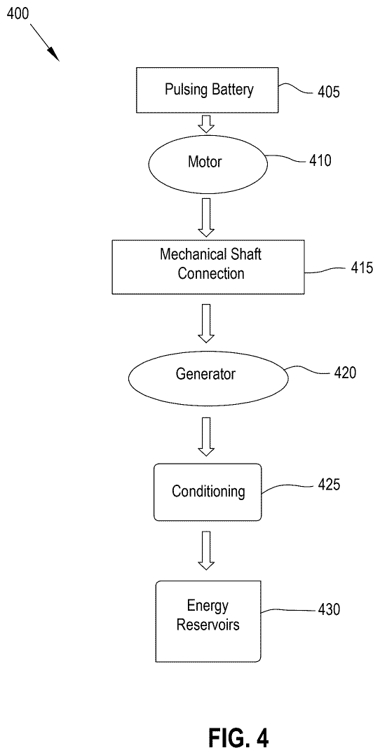

FIG. 4 illustrates an embodiment of an energy transfer arrangement 400 in which electrical energy is transferred from a pulsing battery 405 through an electromechanical conversion chain and returned in conditioned form for storage or reuse.

The energy transfer arrangement 400 includes the pulsing battery 405, which is configured to deliver electrical energy in a pulsed manner rather than as a continuous output. The pulsing battery 405 supplies electrical energy to a motor 410, which converts the received electrical energy into mechanical rotational energy.

The motor 410 is mechanically coupled to a generator 420 through a mechanical shaft connection 415. The mechanical shaft connection 415 transmits rotational energy generated by the motor 410 directly to the generator 420 without intervening electrical conversion.

The generator 420 converts the received mechanical rotational energy into electrical energy. Electrical output from the generator 420 is delivered to a voltage conditioning block 425. The voltage conditioning block 425 is configured to modify one or more electrical characteristics of the generated electrical energy, including voltage level, waveform, or stability, prior to downstream delivery.

Conditioned electrical energy from the voltage conditioning block 425 is supplied to a charge control unit 430. The charge control unit 430 regulates acceptance of the conditioned electrical energy and controls delivery of that energy to downstream storage or system components, as represented by the directional output arrow 435.

As illustrated in FIG. 4, the pulsing battery 405, motor 410, mechanical shaft connection 415, generator 420, voltage conditioning block 425, and charge control unit 430 together form a controlled energy conversion and conditioning chain within the energy transfer arrangement 400. This arrangement enables electrical energy to be transformed through sequential electrical-to-mechanical and mechanical-to-electrical stages prior to regulated output.

The propulsion system further includes a high-power buffer battery that operates as a dedicated intermediate energy reservoir within the overall energy management architecture. The buffer battery is structurally and functionally distinct from the propulsion battery packs and is configured to absorb, store, and redistribute electrical energy under conditions that would otherwise impose excessive electrical or thermal stress on the propulsion battery packs. The buffer battery therefore serves as a mediating element that decouples transient or irregular energy sources from long-duration propulsion energy storage.

In the disclosed architecture, the buffer battery is not treated as an auxiliary propulsion source in the conventional sense. Rather, it is integrated into the system as an energy staging component whose primary function is to regulate the timing, rate, and conditions under which energy is transferred between disparate parts of the system. The buffer battery is selected and controlled to accept high power levels over short to intermediate durations and to deliver energy in a controlled manner compatible with downstream components.

The buffer battery is electrically coupled to the propulsion system through the bidirectional DC-DC converter network described previously. This coupling allows the electronic control unit (ECU) to regulate voltage, current, and direction of energy flow between the buffer battery and other energy domains. The buffer battery is therefore not passively connected to the propulsion bus and does not participate in uncontrolled charge or discharge events. All interaction between the buffer battery and other system components occurs only when expressly authorized by the ECU.

During normal vehicle operation, the buffer battery functions as a primary destination for energy captured from sources characterized by high instantaneous power or variable availability. Regenerative braking events, for example, may generate electrical energy at rates that exceed the preferred charge acceptance characteristics of the propulsion battery packs. Rather than forcing such energy directly into a propulsion pack, the ECU routes regenerative energy into the buffer battery, either directly or after initial capture by the supercapacitor bank. The buffer battery absorbs this energy and retains it until conditions are suitable for further redistribution.

Similarly, energy harvested from the turbine generator and photovoltaic harvester is staged through the buffer battery to smooth fluctuations caused by changes in vehicle speed, airflow, incident light, or turbine operating state. Because aerodynamic or incident light harvesting output may vary rapidly, the buffer battery provides a stabilizing reservoir that prevents these fluctuations from propagating into the propulsion battery packs or propulsion bus. The ECU may modulate turbine operation and buffer battery acceptance concurrently to achieve a desired balance between harvesting efficiency and system stability.

The buffer battery also plays a central role in external charging scenarios. When electrical energy is supplied to the vehicle through an external charging interface, particularly at high power levels, the ECU may direct incoming energy first to the buffer battery rather than directly to a propulsion battery pack. This staging allows the system to accept high instantaneous charging power while subsequently metering energy to the offline propulsion battery pack at a rate selected to optimize longevity and thermal behavior. In this manner, the buffer battery acts as a temporal decoupler between external energy availability and propulsion battery charging constraints.

In addition to absorbing energy, the buffer battery may selectively deliver energy to other system components under ECU control. For example, the buffer battery may supply energy to the supercapacitor bank to replenish its state of charge following boost events. The buffer battery may also supply energy to the motor-generator subsystem to support pulse-charging of the offline propulsion battery pack when other energy sources are unavailable or insufficient. In limited embodiments, the buffer battery may provide supplementary support to the propulsion bus during transient conditions, although such support remains secondary to the propulsion battery packs and is subject to strict authorization criteria.

The ECU continuously evaluates the state of the buffer battery, including its state of charge, temperature, internal resistance, and recent charge-discharge history. Based on this evaluation, the ECU determines whether the buffer battery is available to accept additional energy, to supply energy to other reservoirs, or to remain idle. The ECU may deliberately maintain the buffer battery within a defined operating window rather than maximizing its state of charge, thereby preserving headroom for energy capture during unexpected events.

Integration of the buffer battery with the propulsion battery respiration architecture is intentional and coordinated. While a propulsion battery pack is in the offline state, the buffer battery serves as a primary intermediary through which energy is delivered to that pack. Because the offline pack is isolated from propulsion loads, the ECU can select charging profiles based on pack health and readiness rather than on immediate energy availability. The buffer battery allows energy captured at inconvenient times to be stored until such profiles can be applied.

The buffer battery further enhances fault tolerance within the propulsion system. In the event of a fault affecting one propulsion battery pack, the buffer battery may temporarily support energy redistribution or stabilization while the ECU reconfigures the system. Similarly, if a fault affects an energy harvesting or external charging subsystem, the buffer battery may continue to supply or absorb energy as needed to maintain stable operation of unaffected components.

From a safety perspective, the buffer battery is subject to isolation and protection mechanisms equivalent to those applied to other high-energy components. The ECU may electrically isolate the buffer battery in response to over-temperature, over-voltage, or other abnormal conditions. Because the buffer battery is not required for basic propulsion continuity, such isolation does not necessarily result in loss of vehicle operability, further enhancing system robustness.

Conceptually, the buffer battery enables the propulsion system to treat energy as a schedulable resource rather than as an immediate obligation. By providing a place for energy to reside temporarily, the system gains flexibility in how and when energy is ultimately applied to propulsion battery packs or propulsion loads. This flexibility is essential to achieving the broader objectives of reduced battery stress, improved endurance, and controlled interaction with variable energy sources.

The buffer battery is expressly distinguished from auxiliary propulsion batteries found in certain electric vehicle architectures. In those conventional systems, an auxiliary battery may be selectively coupled to assist propulsion under high load, thereby functioning as a secondary traction source. In contrast, the buffer battery of the present architecture is not intended to serve as a routine propulsion energy source and is not dimensioned or controlled for sustained traction discharge. While limited and conditional support of the propulsion bus may occur under transient or stabilizing conditions, such support is incidental to the buffer battery's staging function and is not a primary operational role.

This distinction is enforced both structurally and logically. Structurally, the buffer battery is coupled to the propulsion system through power electronics that impose current and duration limits inconsistent with sustained propulsion discharge. Logically, the ECU restricts buffer battery discharge to scenarios in which such discharge contributes to system stability, smooth transitions, or energy redistribution rather than to ongoing propulsion demand. This framing prevents mischaracterization of the buffer battery as a hidden propulsion pack and preserves the integrity of the respiration architecture.

The buffer battery's interaction with driver-first safety logic mirrors the principles applied elsewhere in the system. Buffer battery discharge is immediately inhibited in response to braking input, traction control intervention, or stability control intervention where continued discharge could interfere with vehicle controllability. Similarly, buffer battery charging may be curtailed or deferred in response to safety-critical events, thermal constraints, or fault detection. In all cases, buffer battery operation is subordinate to safety outcomes and does not override driver intent.

The ECU further integrates buffer battery behavior with propulsion battery respiration decisions. When a propulsion battery pack is scheduled to assume the online propulsion role, the ECU may adjust buffer battery utilization to ensure that sufficient staged energy is available to support a smooth transition. Conversely, when a propulsion battery pack is expected to remain offline for an extended period, the ECU may utilize the buffer battery to gradually deliver energy in a manner that supports long-term conditioning rather than immediate readiness.

The buffer battery also participates in system-wide derating and degradation management strategies. Over time, the ECU may observe changes in buffer battery charge acceptance, internal resistance, or thermal behavior indicative of aging or stress. In response, the ECU may adjust energy routing priorities, limit buffer battery charge or discharge rates, or reassign staging functions to other intermediate reservoirs such as the supercapacitor bank. These adaptations allow the system to preserve functionality even as individual components age.

The propulsion system further includes a supercapacitor bank integrated into the energy management architecture as a high-power, low-latency energy reservoir distinct from both the propulsion battery packs and the buffer battery. The supercapacitor bank is configured to accept and deliver electrical energy at rates substantially higher than those tolerated by electrochemical batteries and is therefore suited to managing rapid transient energy events that occur during vehicle operation.

In the disclosed architecture, the supercapacitor bank is not treated as a simple supplemental storage element but as an actively managed subsystem whose operating role varies depending on system state, driver input, and energy availability. The electronic control unit (ECU) governs the charging, discharging, and isolation of the supercapacitor bank in a manner that preserves its availability for high-value events while preventing degradation or misuse.

The supercapacitor bank is electrically coupled to the propulsion system through the bidirectional DC-DC converter network. This coupling allows the ECU to regulate the voltage domain, current magnitude, and direction of energy flow between the supercapacitor bank and other energy reservoirs. The supercapacitor bank is therefore insulated from uncontrolled interaction with the propulsion bus or battery terminals, and its participation in system operation is always deliberate.

In operation, the supercapacitor bank performs two principal energy-handling roles that are distinct in purpose and timing. In a first role, the supercapacitor bank is configured to deliver direct propulsion support by discharging energy into the propulsion bus. In this role, energy stored in the supercapacitors supplements propulsion power during transient demand events such as rapid acceleration, torque fill during dynamic maneuvers, or stabilization during propulsion battery respiration transitions. Because the supercapacitor bank can deliver high current with minimal voltage sag, this direct discharge capability allows the system to respond to short-duration power demands without imposing abrupt load changes on the propulsion battery pack currently in the online state.

The ECU strictly governs when direct supercapacitor discharge is permitted. Authorization is conditioned on vehicle operating state, driver input consistency, traction and stability conditions, and readiness of downstream power electronics. Direct discharge is inhibited immediately in response to braking input, traction control intervention, or stability control intervention, thereby ensuring that propulsion enhancement never conflicts with driver intent or vehicle controllability.

In a second role, the supercapacitor bank is configured to deliver energy indirectly through the motor-generator subsystem rather than directly into the propulsion bus. In this role, the ECU commands the supercapacitor bank to discharge energy in controlled pulses into the motor-generator, which then converts that energy into a conditioned electrical output suitable for charging the offline propulsion battery pack. This indirect delivery path allows the system to exploit the supercapacitor bank's high power capability while imposing charging characteristics on the propulsion battery pack that are compatible with longevity and thermal constraints.

The pulsed discharge behavior of the supercapacitor bank is actively shaped by the ECU. Pulse amplitude, duration, and repetition rate may be varied dynamically based on the state of charge of the supercapacitor bank, the readiness of the offline propulsion battery pack, thermal conditions, and the availability of staged energy in the buffer battery. By modulating these parameters, the ECU ensures that energy transfer through the motor-generator remains stable and efficient without subjecting any component to excessive stress.

The supercapacitor bank also functions as a primary capture destination for transient energy sources. Regenerative braking events often produce high instantaneous power that exceeds the preferred acceptance rate of electrochemical batteries. In such cases, the ECU routes regenerative energy first to the supercapacitor bank, allowing that energy to be captured rapidly and without degradation. The captured energy may then be redistributed to the buffer battery or to the offline propulsion battery pack under conditions selected by the ECU.

Similarly, fluctuations in energy output from the turbine generator may be absorbed initially by the supercapacitor bank, particularly when rapid changes in vehicle speed or airflow produce transient output variations. The supercapacitor bank thereby dampens these fluctuations before energy is staged further into the system.

To preserve availability, the ECU maintains the supercapacitor bank within a defined operating window rather than allowing it to remain fully charged or fully depleted for extended periods. Maintaining headroom within the supercapacitor bank ensures that capacity is available both for capturing unexpected energy influx and for delivering immediate propulsion support when needed. The ECU may therefore deliberately bleed or redistribute energy from the supercapacitor bank even in the absence of immediate demand.

Thermal and electrical conditions of the supercapacitor bank are continuously monitored. In the event of elevated temperature, abnormal voltage behavior, or degradation indicators, the ECU may restrict discharge rates, inhibit boost functionality, or temporarily isolate the supercapacitor bank. Because the supercapacitor bank is not required for baseline propulsion continuity, such protective actions do not necessarily compromise vehicle operability.

The integration of the supercapacitor bank with the propulsion battery respiration architecture is deliberate. During transitions between propulsion battery packs, the supercapacitor bank may temporarily support the propulsion bus to ensure continuity and smoothness. During extended offline periods of a propulsion battery pack, the supercapacitor bank may serve as a transient intermediary feeding energy into the buffer battery or motor-generator loop. In this manner, the supercapacitor bank contributes to both short-term responsiveness and long-term energy management objectives.

Conceptually, the supercapacitor bank enables the propulsion system to separate power capability from energy capacity. High instantaneous power demands and high-rate energy capture events are handled by the supercapacitor bank, while sustained energy delivery and storage are handled by the propulsion battery packs. This separation is central to achieving both performance and durability without requiring oversizing of any single component.

Operation of the supercapacitor bank is tightly integrated with the driver-first safety hierarchy governing the propulsion system. Although the supercapacitor bank is capable of delivering substantial instantaneous power, its discharge authority is always conditional. The ECU continuously evaluates braking input, throttle position, gear state, traction conditions, and stability control status before permitting any form of supercapacitor discharge. Upon detection of braking input or a stability intervention, the ECU immediately terminates or inhibits supercapacitor discharge regardless of state of charge or prior authorization. This ensures that the presence of high-power energy storage does not compromise vehicle controllability or driver intent.

The ECU further coordinates supercapacitor behavior with propulsion battery pack transitions. During respiration events, the ECU may authorize limited supercapacitor discharge to maintain propulsion bus stability while contactors are sequenced. However, such discharge is time-bounded and purpose-specific. The supercapacitor bank is not permitted to mask persistent propulsion deficiencies or to substitute indefinitely for a propulsion battery pack that is unable to meet demand. This constraint reinforces the supercapacitor bank's role as a transient support mechanism rather than a hidden propulsion source.

The architecture also avoids any interpretation of the supercapacitor bank as implementing hybrid propulsion in which stored electrical energy is continuously blended into traction output. Supercapacitor participation in propulsion is episodic and conditional, triggered by discrete events such as acceleration transients, respiration transitions, or system stabilization requirements. Sustained propulsion energy remains the responsibility of the propulsion battery pack designated as online, and the ECU actively prevents the supercapacitor bank from being drawn down in a manner inconsistent with this role separation.

Long-term durability of the supercapacitor bank is managed through adaptive control strategies executed by the ECU. Over time, the ECU may observe changes in equivalent series resistance, effective capacitance, thermal response, or charge-retention behavior. In response, the ECU may adjust operating windows, limit peak discharge currents, or alter capture priorities to preserve functional availability. Because the supercapacitor bank is not a consumptive energy source but a high-cycle component, these adaptive strategies allow the system to maintain performance over extended service life without requiring early replacement or oversizing.

The ECU may also coordinate degradation management between the supercapacitor bank and the buffer battery. If supercapacitor performance is temporarily limited due to thermal or aging constraints, the ECU may shift a greater portion of transient energy handling to the buffer battery where appropriate. Conversely, when buffer battery acceptance is constrained, the supercapacitor bank may assume a greater share of capture and smoothing duties. This dynamic allocation allows the system to adapt gracefully to component-specific limitations.

In fault scenarios, the supercapacitor bank may be electrically isolated without disabling the propulsion system as a whole. Because the propulsion battery packs and buffer battery remain available, baseline vehicle operation may continue even if supercapacitor functionality is reduced or suspended. The ECU logs such events and may impose corresponding restrictions on boost or charging behavior until normal conditions are restored.

The propulsion system further includes a motor-generator subsystem that operates as an electromechanical conditioning interface between high-power electrical energy sources and the propulsion battery packs. The motor-generator subsystem is integrated into the energy management architecture as a controllable conversion stage through which energy may be reshaped, moderated, and delivered under conditions selected by the electronic control unit (ECU). Its function is not to provide propulsion torque to the drivetrain, but rather to serve as a regulated intermediary that enables charging behavior not achievable through direct electrical coupling alone.

In the disclosed architecture, the motor-generator subsystem is electrically coupled upstream to the supercapacitor bank and, in certain operating states, to the buffer battery. Downstream, the output of the motor-generator subsystem is conditioned and routed toward the offline propulsion battery pack through the bidirectional DC-DC converter network. This placement allows the motor-generator to operate as a pulse-responsive load on upstream energy reservoirs while simultaneously acting as a controlled charging source for the propulsion battery pack.

The motor-generator subsystem includes at least one rotating electrical machine capable of operating bidirectionally as a motor and as a generator. When operating in its motor mode, the subsystem receives electrical energy in discrete pulses commanded by the ECU. These pulses cause the machine to rotate under controlled torque and speed conditions. When operating in its generator mode, the rotational energy is converted back into electrical energy that is subsequently rectified, filtered, and delivered as a charging current. The separation between input pulses and output charging current allows the ECU to decouple upstream energy dynamics from downstream battery charging characteristics.

The use of an electromechanical conversion stage provides a degree of temporal and electrical smoothing that is difficult to achieve through purely electronic means. The inertia of the rotating machine, combined with controlled pulse timing, allows abrupt electrical inputs to be transformed into more stable output waveforms. As a result, energy originating from highly transient sources, such as supercapacitor discharge or intermittent harvesting, can be delivered to a propulsion battery pack without subjecting that pack to sharp current spikes or irregular charging profiles.

The ECU governs the motor-generator subsystem by controlling pulse amplitude, duration, frequency, and sequencing. These parameters are selected dynamically based on the state of charge, temperature, and readiness of the offline propulsion battery pack, as well as the availability and condition of upstream energy reservoirs. The ECU may further adjust pulse characteristics in response to thermal conditions within the motor-generator itself, ensuring that electromechanical components remain within safe operating limits.

In normal operation, the motor-generator subsystem is utilized primarily when charging the offline propulsion battery pack during vehicle motion. In such cases, energy captured from regenerative braking, aerodynamic harvesting, photovoltaic absorption, or external sources is staged through the supercapacitor bank or buffer battery and then delivered to the motor-generator in a controlled manner. The motor-generator converts this staged energy into a charging current that is compatible with long-term battery health, even when upstream energy availability is intermittent or irregular.

The motor-generator subsystem is not required to operate continuously. The ECU may suspend or bypass motor-generator charging during periods when direct buffer-to-battery charging is preferred or when system conditions do not warrant pulse-conditioned delivery. Conversely, when conditions favor finely controlled charging, such as during thermal recovery or degradation-sensitive operation, the ECU may preferentially route energy through the motor-generator rather than through purely electronic pathways.

Integration of the motor-generator subsystem with the propulsion battery respiration architecture is deliberate. Because the offline propulsion battery pack is electrically isolated from propulsion loads, the ECU is free to impose charging profiles that prioritize longevity and stability over immediacy. The motor-generator subsystem enables such profiles by acting as a controllable intermediary that shields the battery pack from upstream variability. This function is particularly advantageous during sustained driving, where energy capture and propulsion demands overlap in time.

From a safety perspective, operation of the motor-generator subsystem is subordinate to the same driver-first logic governing other energy pathways. Pulse delivery is immediately inhibited in response to braking input, stability intervention, or fault detection. Because the motor-generator does not supply propulsion torque directly, inhibiting its operation does not compromise immediate vehicle control. The ECU may therefore disable the motor-generator conservatively whenever system conditions warrant.

Thermal management of the motor-generator subsystem is coordinated with overall system behavior. The ECU monitors temperature, rotational speed, and electrical loading of the motor-generator and may adjust operating parameters or suspend operation to prevent overheating or mechanical stress. In embodiments where multiple motor-generator units are present, the ECU may distribute charging duties among them to balance wear or to maintain redundancy.

In fault scenarios, the motor-generator subsystem may be electrically isolated without disabling the propulsion system as a whole. Charging of the offline propulsion battery pack may continue through alternate pathways, such as direct buffer-to-battery transfer at reduced rates, or may be deferred until conditions permit restoration of motor-generator functionality. This isolation capability further reinforces the modularity and resilience of the overall architecture.

Conceptually, the motor-generator subsystem enables the propulsion system to translate power flexibility into charging precision. By interposing an electromechanical conversion stage between transient energy sources and long-term storage, the system gains fine-grained control over how energy is ultimately stored without sacrificing the ability to capture that energy when it becomes available.

The motor-generator subsystem is expressly distinguished from drivetrain-coupled generators or traction motor regeneration systems commonly found in hybrid or electric vehicles. The motor-generator described herein does not deliver mechanical torque to the vehicle drivetrain, nor does it recover kinetic energy directly from wheel rotation. Instead, it operates as a dedicated electromechanical conditioning element whose sole purpose is to reshape electrical energy for controlled delivery to an offline propulsion battery pack. This distinction ensures that the motor-generator subsystem cannot be misconstrued as a propulsion component or as part of a hybrid drivetrain architecture.

Because the motor-generator is decoupled from the drivetrain, its operation is governed entirely by energy management objectives rather than by vehicle speed, wheel torque, or mechanical load conditions. The ECU therefore has complete authority over when the motor-generator operates, how it operates, and when it is inhibited. This decoupling allows pulse-conditioned charging to occur independently of driving conditions, provided that upstream energy is available and safety conditions are satisfied.

Coordination between the motor-generator subsystem and the supercapacitor bank is a defining aspect of the pulse-conditioned energy transfer architecture. The ECU may command the supercapacitor bank to discharge energy into the motor-generator in discrete pulses whose timing and magnitude are selected to exploit both the rapid response capability of the supercapacitors and the smoothing characteristics of the rotating machine. In this coordinated operation, the supercapacitor bank supplies short-duration, high-power inputs, while the motor-generator converts those inputs into a steadier output suitable for battery charging.

The ECU may further interleave pulse-conditioned delivery from the motor-generator with direct staging through the buffer battery. For example, when the offline propulsion battery pack exhibits high charge acceptance and favorable thermal conditions, the ECU may increase reliance on motor-generator charging. Conversely, when acceptance is limited or when upstream energy availability is constrained, the ECU may reduce pulse frequency or defer motor-generator operation altogether. This adaptive coordination ensures that the motor-generator subsystem operates only when its benefits outweigh conversion losses.

Long-term durability of the motor-generator subsystem is preserved through active monitoring and adaptive control. The ECU tracks indicators such as operating temperature, rotational speed profiles, electrical loading patterns, and cumulative operating time. Based on these indicators, the ECU may adjust pulse parameters, impose rest intervals, or temporarily disable the subsystem to prevent excessive wear or thermal stress. Because the motor-generator is not required for baseline propulsion continuity, such protective actions can be taken conservatively without compromising vehicle operation.

In embodiments where multiple motor-generator units are provided, the ECU may distribute pulse-conditioning duties among those units to balance usage and enhance fault tolerance. Alternatively, different motor-generator units may be optimized for different operating regimes, such as low-speed conditioning versus high-power pulse handling. These variations do not alter the fundamental role of the motor-generator subsystem as an energy-conditioning intermediary.

The motor-generator subsystem also participates in fault containment within the propulsion system. If abnormal electrical behavior is detected at the interface between upstream reservoirs and the offline propulsion battery pack, the ECU may isolate the motor-generator to prevent propagation of the fault. Charging may then be rerouted through alternate pathways at reduced rates or suspended until corrective action is taken. This isolation capability further reinforces the system's resilience to component-level failures.

The propulsion system further includes a turbine generator subsystem integrated into the energy management architecture as a controlled mechanism for harvesting aerodynamic energy generated during vehicle motion. The turbine generator is configured to convert a portion of airflow incident on the vehicle into electrical energy while remaining subordinate to propulsion performance, driver intent, and vehicle safety. Unlike passive drag-based recovery devices, the turbine generator is actively governed by the electronic control unit (ECU) and participates in the energy system only when its operation is consistent with overall vehicle objectives.

In the disclosed architecture, the turbine generator is treated as a core subsystem whose participation is dynamically enabled, modulated, or suspended. The system does not assume continuous turbine operation, nor does it require aerodynamic harvesting for baseline propulsion. Instead, the turbine generator operates opportunistically under conditions in which harvested energy provides net benefit without imposing unacceptable aerodynamic penalties or interfering with vehicle control.

The turbine generator includes a rotating turbine element exposed to airflow generated by vehicle motion and an electrical generator mechanically coupled to that turbine element. As airflow passes through or across the turbine, mechanical rotation is induced and converted into electrical output. The electrical output is subsequently conditioned and routed into the energy management architecture through controlled power electronics. The turbine generator may be implemented using axial-flow, radial-flow, or mixed-flow turbine geometries, and may be integrated into vehicle bodywork, ducts, or other airflow paths without altering the fundamental control principles described herein.

A defining feature of the turbine generator subsystem is the presence of ECU-controlled airflow modulation. Adjustable aerodynamic elements, such as louvers, vanes, shutters, or variable-geometry passages, are positioned to regulate the amount of airflow incident on the turbine. By adjusting these elements, the ECU controls turbine rotational speed, electrical output, and aerodynamic drag imposed on the vehicle. This control authority allows the system to treat aerodynamic harvesting as a tunable variable rather than as a fixed consequence of motion.

The ECU evaluates vehicle speed, driver inputs, propulsion demand, thermal state, and stability conditions when determining whether to permit turbine operation. Under conditions where propulsion efficiency or acceleration is prioritized, the ECU may restrict airflow to the turbine to minimize drag. Under conditions where sustained cruising or deceleration occurs, the ECU may increase turbine participation to capture available aerodynamic energy. This dynamic modulation ensures that harvesting never overrides propulsion or safety objectives.

Electrical energy generated by the turbine generator is not delivered directly to a propulsion battery pack. Instead, the output is routed through conditioning circuitry and staged into intermediate energy reservoirs, such as the supercapacitor bank or buffer battery, under ECU control. This staging prevents irregular turbine output from being imposed directly on electrochemical batteries and allows harvested energy to be redistributed at times and rates selected for system benefit.

The turbine generator is integrated with regenerative braking logic in a complementary manner. During braking or deceleration events, the ECU may reduce or disable turbine operation to prevent additional aerodynamic drag that could interfere with braking effectiveness or stability. Conversely, during steady-state cruising or downhill operation, turbine harvesting may be increased to supplement regenerative capture without affecting driver braking authority.

Safety integration is central to turbine operation. The ECU immediately restricts or disables turbine airflow in response to braking input, traction control intervention, or stability control intervention. In emergency maneuvers or fault conditions, turbine participation is suspended entirely. Because turbine harvesting is never required for propulsion continuity, disabling the turbine does not compromise vehicle operation and may be done conservatively whenever uncertainty arises.

The turbine generator subsystem further participates in thermal and durability management strategies. Continuous turbine operation at high speeds may generate heat within the generator or associated power electronics. The ECU monitors these conditions and adjusts airflow modulation accordingly. Over time, the ECU may alter turbine usage patterns based on observed efficiency, wear indicators, or environmental conditions to preserve long-term functionality.

In embodiments where multiple turbine generators or distributed turbine elements are employed, the ECU may coordinate their operation to balance aerodynamic impact and energy capture. Alternatively, turbine generators may be selectively enabled based on vehicle orientation, airflow distribution, or operating mode. These variations do not alter the fundamental principle that turbine harvesting is centrally governed and subordinate to propulsion and safety.

The turbine generator subsystem also integrates with external energy interaction modes. During external charging, vehicle-to-vehicle assistance, or vehicle-to-grid operation, the turbine generator is typically disabled to avoid unnecessary drag or electrical interaction. This isolation ensures that turbine harvesting does not complicate external energy management scenarios.

Conceptually, the turbine generator enables the propulsion system to recover a portion of kinetic energy that would otherwise be dissipated as aerodynamic drag, but only when such recovery aligns with broader system objectives. By placing aerodynamic harvesting under explicit control authority, the system avoids the inefficiencies and safety concerns associated with passive or always-on recovery devices.

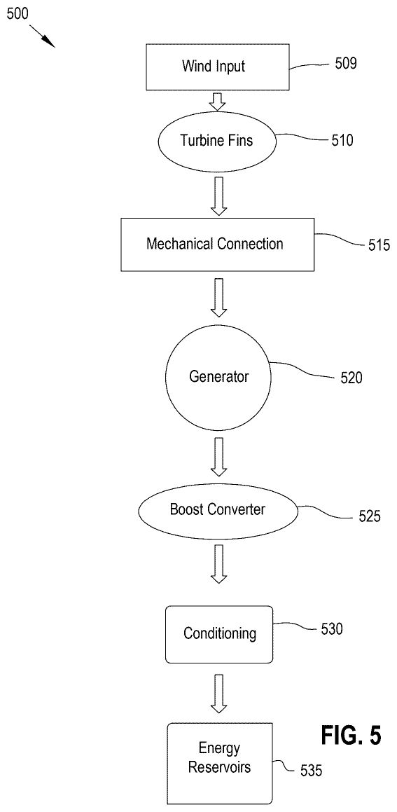

FIG. 5 illustrates an embodiment the turbine generator subsystem 500 configured to convert wind input into conditioned electrical energy for controlled charging. The subsystem 500 includes a wind input 505 representing ambient airflow incident on the vehicle during operation. The wind input 505 is directed toward a set of turbine fins 510, which are configured to interact with the airflow and convert kinetic energy of the wind into mechanical rotational energy.

The turbine fins 510 are mechanically coupled to a generator 520 through a mechanical connection 515. The mechanical connection 515 transmits rotational energy generated by the turbine fins 510 to the generator 520 without intervening electrical conversion.

The generator 520 converts the received mechanical rotational energy into electrical energy. Electrical output from the generator 520 is supplied to a boost converter 525. The boost converter 525 is configured to increase or regulate the voltage level of the generated electrical energy to a level suitable for downstream processing.

Output from the boost converter 525 is delivered to a signal conditioning block 530. The signal conditioning block 530 is configured to modify one or more characteristics of the electrical energy, including waveform stability or signal compatibility, prior to delivery to downstream control circuitry.

Conditioned electrical energy from the signal conditioning block 530 is supplied to a charge control unit 535. The charge control unit 535 regulates acceptance of the conditioned electrical energy and controls delivery of that energy to downstream storage or system components.

As illustrated in FIG. 5, the wind input 505, turbine fins 510, mechanical connection 515, generator 520, boost converter 525, signal conditioning block 530, and charge control unit 535 together form a sequential energy harvesting and conditioning chain within the energy harvesting and transfer arrangement 500. This arrangement enables conversion of wind energy into regulated electrical output through successive mechanical and electrical processing stages.

Coordination between the turbine generator and other energy capture mechanisms is handled explicitly by the ECU. When regenerative braking is active, the ECU may reduce turbine participation to avoid compounding deceleration forces or introducing instability. Conversely, during extended cruising at constant speed, turbine harvesting may be increased while regenerative capture is inactive. This coordination allows the system to distribute energy recovery across multiple mechanisms without overlap or conflict.

Electrical output from the turbine generator is conditioned to accommodate the inherently variable nature of aerodynamic harvesting. Fluctuations in vehicle speed, wind conditions, and airflow dynamics produce corresponding variations in generator output. By routing this output through conditioning electronics and staging reservoirs, the ECU ensures that such variability does not propagate into sensitive downstream components. The supercapacitor bank may be used to absorb rapid fluctuations, while the buffer battery may be used to accumulate harvested energy over longer intervals.

Fault handling within the turbine generator subsystem follows the same isolation-first principles applied elsewhere in the architecture. If abnormal electrical behavior, excessive vibration, or thermal anomalies are detected, the ECU may immediately close airflow modulation elements and electrically isolate the generator. Because turbine harvesting is nonessential, such isolation has no adverse impact on propulsion continuity and may be executed conservatively.

Durability management of the turbine generator includes adaptive usage patterns that respond to observed efficiency and wear indicators. Over time, the ECU may reduce reliance on turbine harvesting if diminishing returns are observed or if environmental conditions render harvesting inefficient. Conversely, under favorable conditions, turbine participation may be increased within defined limits. This adaptability allows the turbine generator to contribute meaningfully without becoming a maintenance burden.

In embodiments intended for varied operating environments, such as urban, highway, or off-road use, the ECU may tailor turbine behavior based on operating mode. For example, turbine harvesting may be minimized during stop-and-go operation and emphasized during steady highway cruising. These operating modes may be selected automatically or in response to high-level driver preferences without altering the underlying control hierarchy.

The turbine generator subsystem is also designed to coexist with vehicle aerodynamic design considerations. Placement, ducting, and airflow modulation are selected to avoid adverse effects on cooling, stability, or noise characteristics. Because turbine operation is adjustable, aerodynamic compromises can be mitigated dynamically rather than being fixed at design time.

The propulsion system further incorporates a photovoltaic energy source configured to harvest electrical energy from incident light and to introduce that harvested energy into the system in a controlled, managed manner. The photovoltaic energy source may be implemented as one or more photovoltaic panels, laminates, coatings, films, or other photovoltaic conversion assemblies distributed across exterior surfaces of the vehicle exposed to light. The photovoltaic energy source is treated as a supplemental and opportunistic energy input whose availability is variable and environment-dependent, and whose output is therefore integrated through controlled power electronics and supervisory control logic so that photovoltaic generation does not interfere with propulsion availability, battery conditioning objectives, safety constraints, or driver control authority.

The photovoltaic energy source is electrically coupled to the propulsion system through power conditioning circuitry and the bidirectional power electronics and energy routing network. Photovoltaic output is variable in voltage and current as a function of irradiance, temperature, and operating conditions, and is therefore conditioned through one or more photovoltaic interface stages prior to delivery to downstream energy reservoirs or system buses. Such interface stages may include maximum power point tracking functionality, DC-DC conversion, voltage regulation, isolation devices, and protective switching elements. The photovoltaic interface stage presents a controlled electrical output compatible with the operating window of the system's intermediate energy reservoirs and the broader bidirectional routing architecture.

Electrical energy generated by the photovoltaic energy source is routed first to intermediate energy reservoirs prior to delivery to propulsion battery packs. This staging behavior decouples photovoltaic generation dynamics from propulsion battery charging behavior and prevents undesirable charge conditions at the propulsion battery packs. Photovoltaic energy accumulated in an intermediate reservoir may subsequently be transferred to an offline propulsion battery pack at controlled rates, thereby allowing photovoltaic harvesting to contribute to propulsion battery respiration objectives. Alternatively, photovoltaic energy may be directed to auxiliary loads or other internal energy domains to reduce net propulsion battery depletion during operation.

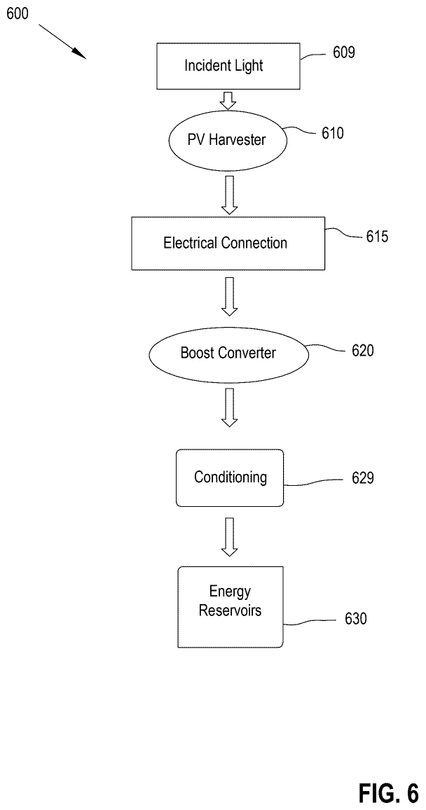

FIG. 6 illustrates an embodiment of a photovoltaic energy harvesting subsystem 600 configured to convert incident light into conditioned electrical energy for controlled charging. The subsystem 600 includes a photovoltaic input 605 representing incident light received by one or more photovoltaic conversion elements disposed on the vehicle during operation or while stationary. The photovoltaic input 605 is directed to a photovoltaic conversion assembly 610 configured to convert incident light into electrical energy.

The photovoltaic conversion assembly 610 generates a variable electrical output in response to lighting conditions and is electrically coupled to a power conditioning stage through an electrical connection 615. The electrical connection 615 conveys electrical energy generated by the photovoltaic conversion assembly 610 to downstream conditioning circuitry without intervening mechanical conversion.

Electrical output from the photovoltaic conversion assembly 610 is supplied to a boost converter 620. The boost converter 620 is configured to increase or regulate the voltage level of the generated electrical energy to a level suitable for downstream processing. Output from the boost converter 620 is delivered to a signal conditioning block 625. The signal conditioning block 625 is configured to modify one or more characteristics of the electrical energy, including waveform stability, voltage regulation, or signal compatibility, prior to delivery to downstream control circuitry.

Conditioned electrical energy from the signal conditioning block 625 is supplied to a charge control unit 630. The charge control unit 630 regulates acceptance of the conditioned electrical energy and controls delivery of that energy to downstream storage or system components.

As illustrated in FIG. 6, the photovoltaic input 605, photovoltaic conversion assembly 610, electrical connection 615, boost converter 620, signal conditioning block 625, and charge control unit 630 together form a sequential energy harvesting and conditioning chain within the photovoltaic energy harvesting subsystem 600. This arrangement enables conversion of incident light into regulated electrical output through successive electrical processing stages.

Photovoltaic harvesting is governed by the ECU as a managed energy input subject to hierarchical control logic. The ECU evaluates system operating state, state of charge and thermal condition of energy reservoirs, fault status, and safety-critical veto conditions to determine whether photovoltaic energy is accepted, curtailed, deferred, or redirected. Where system conditions permit, photovoltaic energy may be authorized for staged transfer into an offline propulsion battery pack undergoing conditioning. Where conditions do not permit, photovoltaic energy acceptance may be limited or inhibited to preserve system stability and safety.

Photovoltaic energy harvesting is coordinated with the bidirectional power electronics and energy routing network so that photovoltaic energy is treated as a peer input alongside regenerative braking energy, turbine generator energy, photovoltaic energy harvested from incident light, and externally supplied energy introduced through external electrical interfaces. The routing network enables photovoltaic energy to be accumulated, redirected, or isolated in accordance with system objectives while preventing undesired coupling between energy domains or uncontrolled voltage rise on shared buses.

The photovoltaic energy source includes protective and isolation mechanisms to ensure safe operation under fault, service, or abnormal conditions. The photovoltaic energy source may be electrically disconnected from downstream circuitry during fault isolation events, collision detection events, or service operations. Protective functions may include over-voltage protection, over-current protection, reverse current prevention, ground fault detection, and thermal protection, with diagnostic information recorded by the event data recording subsystem.

Photovoltaic harvesting supports vehicle operating states in which other harvesting sources are unavailable or diminished, including stationary or low-speed conditions. In such states, photovoltaic energy may be used to maintain battery conditioning objectives, sustain low-power system domains, or reduce net depletion from auxiliary loads without activating higher-power propulsion domains. Photovoltaic harvesting thereby contributes to extended vehicle energy posture while remaining subordinate to safety, control, and physics-compliance constraints.

The propulsion system further includes a bidirectional power electronics and energy routing network that electrically interconnects the propulsion battery packs, buffer battery, supercapacitor bank, motor-generator subsystem, turbine generator, photovoltaic harvester, and external electrical interfaces. This network provides the controlled pathways through which energy is transferred among system components and serves as the physical embodiment of the permission-based energy routing model governed by the electronic control unit (ECU).

In the disclosed architecture, energy is not permitted to flow freely between reservoirs based solely on voltage differentials or passive circuit behavior. Instead, all meaningful energy transfers are mediated by power electronic devices, including bidirectional DC-DC converters, inverters, rectifiers, and controlled contactors. These devices are selectively actuated by the ECU to regulate voltage levels, current magnitudes, and direction of energy flow in accordance with evaluated system conditions.

The bidirectional nature of the converter network allows energy to move flexibly between reservoirs without assuming a fixed source-sink relationship. For example, energy may be transferred from the supercapacitor bank to the buffer battery, from the buffer battery to the motor-generator subsystem, from the turbine generator or photovoltaic harvester to the supercapacitor bank, or from an external source to an intermediate reservoir. In each case, the ECU determines whether the transfer is permitted, the rate at which it occurs, and the duration of the transfer.

Electrical isolation is a central function of the routing network. Each major energy reservoir is capable of being electrically isolated from the remainder of the system through ECU-controlled switching elements. This isolation capability allows faults to be contained locally, prevents unintended backfeeding, and enables selective participation of subsystems without requiring system-wide reconfiguration. Isolation also supports maintenance, diagnostics, and safe startup or shutdown sequences.

Voltage domain management is another critical function of the power electronics network. Different energy reservoirs may operate at different nominal voltage levels optimized for their respective functions. The converter network translates energy between these voltage domains while maintaining electrical compatibility and protecting downstream components. This translation capability allows the architecture to integrate heterogeneous energy storage technologies without imposing uniform voltage requirements.

The ECU continuously monitors electrical parameters throughout the routing network, including voltages, currents, temperatures, and switching states. Based on this monitoring, the ECU may adjust converter operating modes, limit transfer rates, or inhibit transfers entirely. These adjustments may occur dynamically in response to transient events or gradually as part of long-term system optimization.

Integration of the routing network with driver-first safety logic ensures that energy transfers do not interfere with vehicle control. For example, energy transfers that could influence propulsion bus stability are curtailed during braking events, traction control intervention, or stability control intervention. Similarly, external energy interaction through the routing network is suspended during conditions where such interaction could compromise safety or drivability.

The routing network also enables coordinated sequencing of complex operations, such as propulsion battery respiration transitions or staged charging events. During such operations, the ECU may actuate multiple converters and contactors in a defined sequence to ensure smooth transitions without electrical disturbance. The availability of intermediate reservoirs allows the routing network to maintain stability even as connections are reconfigured.

From a durability perspective, the power electronics network is operated within defined thermal and electrical limits. The ECU may derate converters, distribute load among parallel devices, or schedule energy transfers to avoid sustained stress on any single component. Over time, the ECU may adapt routing strategies based on observed converter performance and environmental conditions.

The routing network further supports scalability and extensibility of the propulsion system. Additional energy reservoirs, harvesting devices, or external interfaces may be integrated by connecting them to the network and extending ECU control logic, without altering the fundamental architecture. This modularity allows the system to evolve across vehicle platforms and power levels.

The bidirectional power electronics and energy routing network further provides the structural foundation for controlled interaction between the propulsion system and external electrical interfaces. When electrical energy is exchanged across the vehicle boundary, whether received from an external source or delivered to an external load, that exchange is mediated entirely through the routing network under ECU authority. External interfaces are never hard-coupled to propulsion battery packs or to the propulsion bus. Instead, external energy is introduced into or withdrawn from the system through intermediate stages that preserve isolation and allow system conditions to be evaluated continuously.

During external energy receipt, the ECU determines an appropriate destination for incoming energy based on system state. Energy may be routed initially to the buffer battery or supercapacitor bank to absorb high instantaneous power, or may be delivered in a conditioned manner toward an offline propulsion battery pack. The routing network enforces current limits, voltage alignment, and sequencing to ensure that external interaction does not introduce instability or exceed component limits. If conditions change during external energy transfer, the ECU may redirect or suspend routing without requiring disconnection at the external interface.

During external energy delivery, the routing network similarly ensures that outgoing energy is drawn from reservoirs selected to preserve propulsion readiness. The ECU may restrict external delivery to staged reservoirs rather than propulsion battery packs, or may limit delivery based on predicted propulsion demand. In this manner, the routing network allows participation in external energy ecosystems without compromising the primary function of vehicle propulsion.

Fault detection and containment within the routing network are handled through continuous monitoring and selective isolation. If abnormal voltage, current, temperature, or switching behavior is detected in a converter, contactor, or interconnection, the ECU isolates the affected segment while maintaining operation of unaffected portions of the system. Because energy pathways are segmented and actively controlled, faults are prevented from cascading across reservoirs or propagating into propulsion-critical domains.

The routing network further supports safe startup and shutdown behavior. During vehicle startup, the ECU executes a defined energization sequence in which reservoirs are connected gradually and voltage domains are aligned before allowing propulsion capability. During shutdown, the ECU similarly sequences disconnection to avoid trapped energy, uncontrolled discharge, or unsafe voltage conditions. These sequences are enforced by the routing network rather than relying on passive circuit behavior.

Recovery from fault or abnormal conditions is likewise facilitated by the routing network's modularity. Once a fault is cleared or conditions normalize, the ECU may reintroduce isolated components incrementally, verifying compatibility at each step. This controlled reintegration reduces the likelihood of repeated faults and supports graceful recovery without requiring full system reset.

The routing network also enables adaptive behavior over the operational life of the vehicle. As components age or environmental conditions vary, the ECU may alter routing strategies to redistribute electrical stress. For example, the ECU may favor certain converters over others, reduce peak transfer rates, or modify sequencing to account for observed performance trends. These adaptations allow the routing network to continue functioning reliably even as individual elements experience wear.

In embodiments where redundancy is implemented within the routing network, such as parallel converters or alternate pathways, the ECU may dynamically select among available routes to maintain functionality. This redundancy further enhances fault tolerance and supports continued operation under partial system degradation.

The propulsion system further includes one or more external electrical interfaces that enable controlled exchange of electrical energy between the vehicle and external entities. These interfaces are integrated into the energy management architecture as governed entry and exit points for energy, rather than as direct charging or export terminals. All external energy interaction is therefore subject to the same centralized control, isolation, and safety principles that govern internal energy routing.

In the disclosed architecture, external electrical interfaces are not electrically hard-coupled to propulsion battery packs or to the propulsion bus. Instead, external interfaces are connected to the bidirectional power electronics and energy routing network and are operated under explicit authorization by the electronic control unit (ECU). This configuration allows the ECU to evaluate system conditions before permitting energy exchange and to direct energy through appropriate intermediate reservoirs.

External electrical interfaces may support receipt of energy from stationary charging infrastructure, mobile power sources, or other vehicles. In each case, incoming energy is conditioned and staged rather than being delivered directly to long-term propulsion storage. When high-power external energy is available, the ECU may initially route that energy to the buffer battery or supercapacitor bank to absorb instantaneous power while subsequently metering energy toward an offline propulsion battery pack at rates selected for longevity and thermal stability. This approach allows the system to accept a wide range of external power profiles without requiring propulsion batteries to tolerate extreme charging conditions.

The external interfaces may also support delivery of energy from the vehicle to external loads. Such delivery may occur in contexts where the vehicle functions as a mobile energy resource, emergency power supply, or participant in a distributed energy environment. In these embodiments, the ECU determines which internal reservoirs may supply energy externally while preserving sufficient energy to maintain propulsion readiness. Energy delivery is therefore conditional, reversible, and interruptible.

The ECU evaluates multiple criteria before authorizing external energy exchange. These criteria include state of charge of propulsion battery packs, readiness of intermediate reservoirs, predicted propulsion demand, thermal conditions, and fault status. External exchange may be suspended or limited dynamically if conditions change. This dynamic governance ensures that external interaction remains subordinate to the vehicle's primary propulsion function.

Electrical isolation plays a critical role in external energy management. The routing network enforces galvanic and logical separation between external interfaces and propulsion-critical domains. In the event of external fault conditions, such as abnormal voltage or current behavior, the ECU isolates the external interface without propagating disturbance into the internal system. This containment allows external faults to be managed independently of vehicle propulsion operation.

The external electrical interfaces further support staged engagement and disengagement sequences. When initiating external energy exchange, the ECU may perform voltage alignment, impedance checks, and handshake validation before permitting significant power flow. During disengagement, energy transfer is tapered and isolated in a controlled manner to avoid arcing, transient spikes, or trapped energy. These sequences are enforced through the routing network rather than relying on external equipment behavior.

In embodiments where multiple external interfaces are present, such as separate ports for charging and energy export, the ECU coordinates their operation to prevent conflicting interactions. For example, the ECU may prevent simultaneous high-power charging and external energy delivery or may prioritize one interface based on system state. This coordination prevents external demands from undermining internal stability.

The external electrical interfaces are also integrated with safety and driver-first logic. External energy exchange is typically inhibited while the vehicle is in motion or under driver control, unless explicitly permitted by operating mode and safety conditions. If the vehicle transitions from a stationary to an active propulsion state, the ECU suspends external exchange before enabling propulsion. This behavior prevents inadvertent coupling between propulsion and external systems.

Managed behavior during vehicle-to-vehicle and vehicle-to-infrastructure interaction is governed by the same principles that apply to all other energy routing decisions within the system. When interacting with another vehicle or with stationary infrastructure, the ECU evaluates not only instantaneous electrical compatibility but also anticipated duration, system readiness, and potential impact on propulsion availability. Energy exchange is therefore not treated as a static connection but as an ongoing, supervised process that may be adjusted or terminated as conditions evolve.

In vehicle-to-vehicle interaction scenarios, the ECU may permit temporary energy delivery to another vehicle under circumstances where such delivery does not impair the host vehicle's ability to operate safely. The ECU continuously monitors internal reservoir states during such interaction and may curtail or suspend delivery if propulsion readiness falls below a defined margin. Conversely, when receiving energy from another vehicle, the ECU stages that energy through intermediate reservoirs to avoid imposing unpredictable charging profiles on propulsion battery packs.

Vehicle-to-infrastructure interaction is similarly governed. When connected to fixed infrastructure, the ECU may allow higher power levels than would be acceptable from mobile sources, but still stages and meters energy according to internal constraints. If infrastructure behavior deviates from expected parameters, the ECU isolates the interface and reverts to internal energy management without interruption to vehicle systems.

Fault scenarios associated with external exchange are handled conservatively. Abnormal voltage, current imbalance, loss of communication, or detection of unsafe conditions at the external interface result in immediate isolation of that interface by the routing network. Because external interfaces are not directly coupled to propulsion-critical components, such isolation does not propagate instability into the propulsion system. The ECU may log the event and inhibit subsequent external exchange until corrective action is taken.

Mode-dependent behavior further refines external energy interaction. In operating modes where propulsion readiness is paramount, such as performance-oriented or emergency response modes, the ECU may restrict or prohibit external exchange regardless of external availability. In modes oriented toward stationary operation or energy support, such as auxiliary power or standby modes, the ECU may permit more extensive external interaction while enforcing safeguards to ensure that propulsion capability can be restored promptly.

The ECU may also coordinate external exchange with environmental and regulatory considerations. For example, energy delivery to external loads may be limited based on location, time of day, or operating context to comply with applicable requirements. These considerations are integrated into authorization logic rather than being handled as external exceptions.

Long-term operational considerations include tracking cumulative external exchange activity and its impact on internal components. The ECU may adjust participation in external energy ecosystems based on observed wear, efficiency trends, or thermal behavior. This adaptive approach allows the system to balance the benefits of external interaction against long-term durability.

The propulsion system is governed by an electronic control unit (ECU) that functions as the centralized authority for energy management, propulsion coordination, and safety enforcement. The ECU is not a passive monitoring device but an active decision-making controller that evaluates system state, authorizes energy transfers, and enforces hierarchical priorities across all subsystems described herein. Through this centralized governance, the ECU ensures that the complexity of the multi-reservoir architecture remains transparent to the driver while preserving predictable and safe vehicle behavior.

The ECU receives input from a distributed sensing infrastructure that includes electrical measurements, thermal measurements, mechanical state indicators, driver inputs, and vehicle dynamics signals. Electrical inputs include voltages, currents, and switching states associated with each energy reservoir and power electronic component. Thermal inputs include temperatures and gradients within battery packs, buffer batteries, supercapacitors, power electronics, and rotating machinery. Mechanical and vehicle-state inputs include vehicle speed, acceleration, braking status, traction control activity, and stability control intervention. Driver inputs include accelerator position, brake application, gear selection, and operating mode selection where applicable.

Based on these inputs, the ECU maintains a continuously updated representation of system state. This representation is not limited to instantaneous measurements but includes inferred conditions such as component readiness, energy availability, and projected near-term demand. The ECU uses this state representation to determine which actions are permissible at any given moment and which must be deferred or prohibited.

Control authority within the ECU is organized according to a hierarchical logic structure that prioritizes safety and driver intent above energy optimization or efficiency objectives. At the highest level of this hierarchy are safety-critical conditions, including braking events, traction loss, stability interventions, fault detection, and emergency states. When such conditions are present, the ECU immediately constrains or disables energy management actions that could interfere with safe vehicle operation. Energy harvesting, boost functionality, staged charging, and external energy exchange are all subordinated to these safety imperatives.

Below safety-critical control lies driver intent enforcement. The ECU interprets driver inputs as expressions of desired vehicle behavior rather than as direct commands to individual subsystems. For example, accelerator input is interpreted as a request for propulsion torque, not as a request to discharge a particular battery or engage a particular reservoir. The ECU translates driver intent into propulsion behavior while selecting internal energy pathways that satisfy that behavior without violating safety or durability constraints.

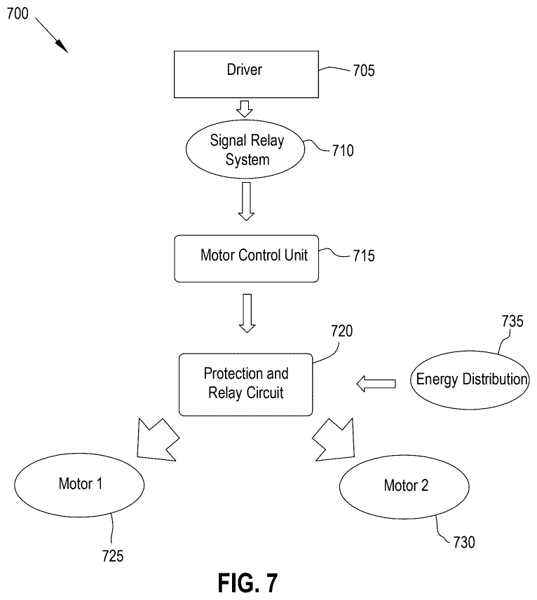

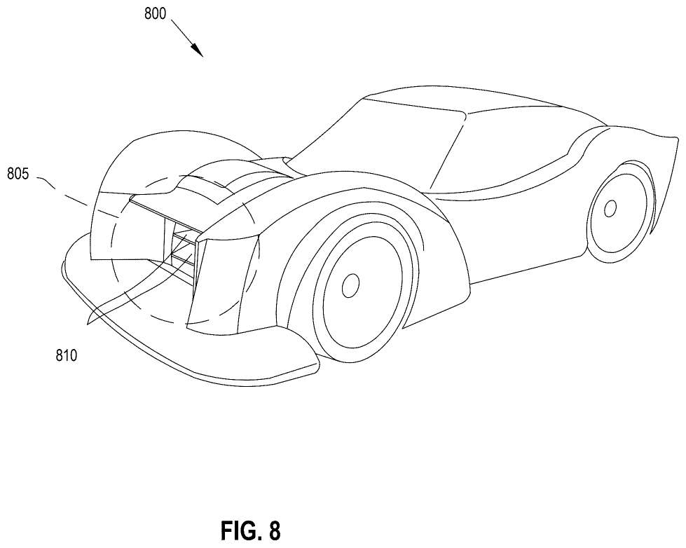

FIG. 7 illustrates a driver command and motor power distribution architecture 700 configured to translate driver inputs into controlled operation of multiple propulsion motors. The architecture 700 includes a driver input source 705 representing operator-generated control signals such as acceleration or propulsion requests.

Driver input signals from the driver input source 705 are communicated to a signal relay system 710. The signal relay system 710 is configured to condition, route, or gate driver input signals prior to delivery to downstream control components, thereby enabling controlled propagation of driver commands within the propulsion control architecture.

Output from the signal relay system 710 is supplied to a motor control unit 715. The motor control unit 715 processes the received driver command signals and generates control outputs corresponding to desired motor operation. The motor control unit 715 may implement control logic to coordinate operation of multiple motors based on driver demand and system conditions.

Control outputs from the motor control unit 715 are routed through a protection and relay circuit 720. The protection and relay circuit 720 provides electrical isolation, fault protection, and selective enablement of motor drive pathways, ensuring that downstream motor operation occurs only under permitted conditions.

Electrical energy is delivered from the protection and relay circuit 720 to a first propulsion motor 725 and a second propulsion motor 730. The first propulsion motor 725 and the second propulsion motor 730 operate as independently controllable drive units capable of delivering propulsion torque in response to control signals originating from the motor control unit 715.

The first propulsion motor 725 and the second propulsion motor 730 are electrically coupled to an energy distribution system 735. The energy distribution system 735 is configured to allocate electrical power to the motors and to manage distribution of energy across multiple propulsion paths, supporting coordinated or differential motor operation as required.

As illustrated in FIG. 7, the driver input source 705, signal relay system 710, motor control unit 715, protection and relay circuit 720, propulsion motors 725 and 730, and energy distribution system 735 together form a controlled command and power delivery chain that enables driver-directed propulsion through multiple motors while maintaining protection, isolation, and managed energy distribution.

Energy management objectives occupy a lower tier of the control hierarchy. These objectives include optimizing battery longevity, maximizing capture of recoverable energy, balancing thermal loads, and maintaining readiness of offline components. The ECU pursues these objectives opportunistically, only when higher-priority safety and driver-intent conditions are satisfied. If a conflict arises, energy optimization behavior yields immediately and automatically.

The hierarchical structure of ECU control allows multiple subsystems to operate concurrently without conflict. For example, while the vehicle is cruising steadily, the ECU may simultaneously permit turbine energy harvesting, staged charging of an offline propulsion battery pack, and conditioning of intermediate reservoirs. If the driver initiates braking or rapid acceleration, those energy management activities are curtailed or reconfigured in real time without requiring explicit state transitions or mode changes.

The ECU also enforces permission-based energy routing consistent with the architecture described in earlier sections. Energy does not move between reservoirs unless the ECU has explicitly authorized that movement based on evaluated conditions. This authorization may be time-limited, conditional, or revocable. The ECU continuously reassesses authorization as conditions change, allowing it to terminate or modify energy transfers dynamically.

Coordination among subsystems is achieved through synchronized control actions rather than through sequential or blocking operations. For example, during a propulsion battery respiration transition, the ECU may coordinate contactor actuation, supercapacitor discharge, and buffer battery support in overlapping timeframes to preserve propulsion continuity. This coordination relies on predictive control rather than reactive correction.

The ECU further implements fault-aware control logic that adapts system behavior in response to detected anomalies. When a fault is detected in a subsystem, the ECU evaluates the severity and scope of the fault and determines appropriate isolation or derating actions. Fault handling is localized where possible, allowing unaffected subsystems to continue operating. The hierarchical logic ensures that fault responses do not cascade unnecessarily or produce unintended side effects.

In embodiments supporting multiple operating modes, such as performance-oriented operation, efficiency-oriented operation, or stationary energy support, the ECU adjusts internal priorities and thresholds while preserving the overall hierarchy. Safety and driver intent remain dominant in all modes, while energy management behavior is tuned to the selected context. Mode changes do not bypass safety constraints or alter fundamental control relationships.

The ECU also supports adaptive behavior over the operational life of the vehicle. By observing trends in component performance, thermal behavior, and energy flow patterns, the ECU may refine control parameters to maintain desired behavior as components age. These adaptations occur within predefined boundaries and do not compromise safety or predictability.

System observability is an integral function of the electronic control unit and supports both real-time decision-making and long-term operational integrity. The ECU continuously records operational parameters associated with energy routing decisions, reservoir states, control authorizations, and safety interventions. This recorded information reflects not only what actions were taken but also the contextual conditions under which those actions were authorized or inhibited. By maintaining this contextual awareness, the ECU supports accurate diagnosis of system behavior and informed adjustment of control strategies over time.

The ECU further implements structured data retention mechanisms that preserve relevant operational history across defined time horizons. Short-term data supports immediate control stability and fault correlation, while longer-term data supports identification of trends related to degradation, efficiency, and usage patterns. Data retention is managed in a manner that avoids interference with real-time control functions and preserves determinism in safety-critical operations.

Adaptive behavior within the ECU is bounded and conservative. While the ECU may adjust thresholds, timing parameters, or prioritization weights in response to observed system behavior, such adaptation occurs within predefined envelopes that preserve safety and predictability. For example, if the ECU observes gradual changes in battery charge acceptance or thermal response, it may modify staging behavior or derating thresholds accordingly. These adaptations are incremental and reversible and do not alter the fundamental hierarchy of control priorities.

Coordination between the ECU and other vehicle control modules is achieved through defined interfaces that preserve separation of responsibilities. Propulsion torque requests, braking commands, and stability interventions originate from vehicle dynamics or driver-interface controllers and are interpreted by the ECU as constraints and objectives rather than as directives to specific energy reservoirs. Conversely, the ECU provides status information and availability indicators to other controllers without exposing internal energy management complexity.

In embodiments supporting automated or assisted driving functions, the ECU treats such functions as extensions of driver intent rather than as overrides of the control hierarchy. Automated propulsion requests are subject to the same safety constraints, energy availability evaluations, and authorization logic as manual driver inputs. This consistency ensures that automation does not bypass safeguards or introduce unintended interactions with energy management functions.

The ECU also supports coordinated recovery following abnormal or fault conditions. After isolating affected components and stabilizing system behavior, the ECU may gradually restore functionality as conditions permit. Restoration occurs through controlled sequencing rather than abrupt re-engagement, ensuring that system stability is maintained throughout recovery. The ECU may adjust recovery behavior based on the nature of the fault and the operational context.

The hierarchical control logic implemented by the ECU further enables graceful degradation. When full functionality cannot be maintained due to component limitations or environmental constraints, the ECU prioritizes maintaining safe, predictable propulsion behavior over maximizing performance or energy capture. Reduced capability is communicated implicitly through vehicle response rather than requiring explicit driver intervention.

From a system integration perspective, the ECU's role as a centralized authority simplifies verification and validation of the propulsion system. Because all meaningful energy routing decisions are mediated by a single control entity operating under a defined hierarchy, system behavior remains comprehensible and bounded even as the underlying hardware architecture grows in complexity.

Fault detection within the system relies on continuous monitoring of electrical, thermal, and mechanical parameters across all energy reservoirs and power electronic components. Electrical monitoring includes detection of over-voltage, under-voltage, over-current, current imbalance, insulation faults, and unexpected switching behavior. Thermal monitoring includes absolute temperature limits, temperature gradients, and rates of change indicative of abnormal heating. Mechanical and electromechanical monitoring includes vibration signatures, rotational anomalies in the motor-generator and turbine generator, and sensor consistency checks.

Upon detection of a fault or unsafe condition, the ECU evaluates the severity, scope, and potential impact of the condition. Not all detected anomalies require immediate system-wide response. Minor deviations may be handled through derating, redistribution of energy routing, or temporary inhibition of affected subsystems. More severe faults trigger immediate protective action, including electrical isolation of the affected component or subsystem.

Protective isolation is achieved through the bidirectional power electronics and routing network. Each major energy reservoir and subsystem is capable of being electrically isolated under ECU command. Isolation actions are executed in a controlled sequence designed to prevent secondary disturbances such as voltage spikes, arcing, or trapped energy. Because energy routing is permission-based, isolation of one pathway does not result in uncontrolled flow through alternate paths.

Safety behavior is explicitly integrated with driver-first control logic. When braking input, traction control intervention, or stability control intervention is detected, the ECU immediately constrains or suspends energy management actions that could interfere with vehicle control. This includes inhibition of propulsion boost, suspension of staged charging events, and restriction of energy harvesting. These actions are taken preemptively and do not require confirmation of a fault condition.

The system further supports fail-operational behavior where feasible. In the presence of localized faults, the ECU may reconfigure the propulsion system to continue operation using unaffected components. For example, if one propulsion battery pack is isolated due to a fault, the system may continue operating using the remaining pack with adjusted performance limits. Intermediate reservoirs such as the buffer battery and supercapacitor bank may assist in stabilizing the system during reconfiguration.

Redundancy within sensing and control pathways further enhances safety. Critical measurements may be obtained from multiple sensors, and the ECU may perform cross-checks to detect inconsistencies. When discrepancies arise, the ECU may favor conservative assumptions and restrict system operation until consistency is restored. This conservative bias ensures that uncertain conditions do not escalate into unsafe behavior.

The safety system also includes controlled shutdown capability. In circumstances where continued operation cannot be maintained safely, the ECU may execute a controlled reduction of propulsion output followed by orderly system shutdown. Shutdown sequencing ensures that energy is dissipated or isolated safely and that the vehicle remains controllable during deceleration. Abrupt loss of propulsion or uncontrolled electrical behavior is avoided.

Environmental and external factors are also considered within the safety framework. Extreme ambient temperatures, immersion, contamination, or external electrical disturbances may trigger protective behavior. The ECU may adjust operating limits or isolate affected subsystems to account for such conditions. These protections ensure robust operation across a wide range of real-world environments.

Safety state transitions are managed deliberately rather than implicitly. When a fault condition clears or an unsafe condition subsides, the ECU may permit gradual restoration of functionality through controlled sequencing. This restoration avoids rapid re-engagement that could reintroduce instability. The ECU may require confirmation of stable conditions over a defined interval before reauthorization.

The ECU further manages transitional safety states during fault response. Rather than treating safety as a binary condition, the system may enter intermediate protective states in which certain functions are inhibited while others remain available. For instance, energy harvesting may be disabled while propulsion continues, or external exchange may be suspended while internal routing remains active. These intermediate states allow the system to remain operational within safe bounds rather than defaulting to full shutdown.

Recovery and requalification following a fault are governed by deliberate procedures executed by the ECU. Once a fault condition is no longer detected, the ECU evaluates whether reintroduction of the affected subsystem is permissible. This evaluation may include confirmation that electrical parameters have returned to normal ranges, that thermal conditions have stabilized, and that no residual anomalies remain. Requalification may require satisfaction of stability criteria over a defined period rather than instantaneous clearance.

When reintroducing an isolated subsystem, the ECU performs controlled sequencing similar to startup behavior. Electrical connections are restored gradually, voltage domains are aligned, and energy transfers are limited initially. This controlled re-engagement reduces the likelihood of recurring faults or transient disturbances. If abnormal behavior reappears during requalification, the ECU may revert to isolation without impacting unaffected subsystems.

Interaction between safety systems and external electrical interfaces follows the same conservative principles. External energy exchange is immediately suspended upon detection of internal or external faults that could compromise safety. The routing network isolates external interfaces independently of internal reservoirs, allowing the propulsion system to continue operating without external interaction. Reauthorization of external exchange occurs only after internal safety conditions are fully restored.

The safety system also accommodates maintenance and diagnostic states. When the vehicle is not in active propulsion operation, the ECU may permit selective energization of subsystems for testing or calibration while maintaining protective isolation from propulsion-critical domains. These states are managed explicitly and are not accessible during normal driving operation.

In scenarios involving multiple concurrent anomalies, the ECU applies layered safety responses rather than attempting to resolve all conditions simultaneously. Higher-severity conditions take precedence, and lower-severity functions are inhibited first. This layered approach prevents cascading reactions and preserves clarity of system behavior during complex fault scenarios.

The safety framework further supports regulatory and operational requirements across different vehicle classes. While specific thresholds and responses may be tailored to application context, the underlying principles of continuous monitoring, hierarchical evaluation, controlled isolation, and deliberate recovery remain consistent. This consistency simplifies validation and enhances confidence in system behavior.

The propulsion system further includes an event data recording and diagnostic subsystem that operates in conjunction with the electronic control unit (ECU) to provide continuous visibility into system operation. This subsystem is integrated as an active element of the control architecture rather than as an after-the-fact logging mechanism. Its purpose is to capture operational context, support fault analysis, enable informed maintenance, and facilitate adaptive system behavior over the service life of the vehicle.

The event data recording subsystem continuously observes electrical, thermal, mechanical, and control-related parameters associated with all major energy reservoirs and power electronic components. Recorded parameters include, but are not limited to, energy routing decisions, reservoir states, converter operating modes, safety interventions, and subsystem availability. Importantly, the subsystem records not only raw measurements but also the authorization states and control rationales that led to particular system actions. This contextual recording allows later reconstruction of system behavior with clarity and precision.

Data acquisition occurs during all operating states of the vehicle, including propulsion operation, energy harvesting, external energy exchange, fault handling, and recovery. Recording is therefore not limited to exceptional events but encompasses normal operation as well. This comprehensive coverage enables differentiation between expected behavior and anomalies and supports identification of gradual trends that may not trigger immediate faults.

The event data recording subsystem employs structured data retention strategies to balance completeness with practicality. High-resolution data may be retained over short rolling intervals to support immediate diagnostics, while summarized or down-sampled data may be preserved over longer durations to support trend analysis. Retention policies are configured to ensure that safety-critical information is preserved without overwhelming storage resources or interfering with real-time control functions.

Diagnostic functionality is closely integrated with event recording. The ECU may access recorded data to corroborate sensor readings, validate control decisions, or assess subsystem health. When faults or abnormal conditions are detected, the diagnostic subsystem uses recorded context to distinguish transient anomalies from persistent issues. This distinction allows the ECU to select appropriate responses, such as temporary derating versus long-term isolation.

The diagnostic subsystem further supports proactive maintenance by identifying patterns indicative of emerging degradation. For example, repeated thermal excursions, increasing charge acceptance variability, or prolonged reliance on intermediate reservoirs may signal changes in component performance. By identifying such patterns early, the system enables corrective action before faults manifest as operational limitations.

System transparency is enhanced through controlled access to diagnostic information. In appropriate embodiments, diagnostic data may be made available to service tools, fleet management systems, or authorized external systems. Access is mediated to prevent interference with control functions and to preserve data integrity. Transparency is therefore achieved without compromising safety or security.

The event data recording subsystem also supports validation and compliance activities. By maintaining a detailed operational history, the system provides objective evidence of how it behaves under a wide range of conditions. This history may be used to verify adherence to safety requirements, performance envelopes, or operational constraints applicable to the vehicle class.

During fault recovery or requalification procedures, recorded data assists the ECU in determining whether conditions have stabilized sufficiently to permit restoration of functionality. The ECU may require confirmation, based on recorded trends, that parameters have remained within acceptable ranges over a defined interval before reauthorizing certain operations. This use of historical context enhances robustness and reduces the likelihood of oscillation between faulted and normal states.

The event data recording subsystem is designed to operate transparently to the driver. Recording and diagnostic functions do not require driver awareness or intervention during normal operation. Any information presented to the driver is abstracted to maintain clarity and avoid distraction, while detailed data remains available for diagnostic and analytical purposes.

The ECU may reference recorded data when selecting among permissible control strategies. For example, if historical records indicate that a particular energy routing pattern consistently produces elevated thermal response under specific conditions, the ECU may favor an alternative routing pattern when similar conditions arise. Such selection occurs within the established hierarchy of control and does not override safety or driver-intent constraints.

Data integrity is maintained through controlled access and validation mechanisms. Recorded data is protected against corruption or unintended modification, and the ECU may perform consistency checks to ensure that stored information remains reliable. Where data is transmitted to external diagnostic tools or management systems, transfer occurs through authenticated interfaces that preserve confidentiality and prevent interference with control functions.

Retention boundaries are defined to balance diagnostic value with practical constraints. While certain categories of data may be retained for extended periods to support long-term analysis, other data is retained only transiently to support immediate control stability or fault correlation. Retention policies may be adjusted based on vehicle class, operating environment, or regulatory requirements without altering the fundamental recording architecture.

Considerations related to privacy and data ownership are accommodated through selective abstraction and access control. Detailed operational data remains internal to the propulsion system unless explicitly authorized for external use. When data is shared, it may be filtered or aggregated to convey necessary information without exposing sensitive details. This controlled transparency allows diagnostic and fleet-level insight without compromising individual vehicle integrity.

The event data recording subsystem also supports coordinated operation in fleet or networked environments. When vehicles participate in shared energy ecosystems or fleet management frameworks, recorded data may be used to inform higher-level optimization decisions, such as scheduling of external energy exchange or maintenance planning. Such use is subordinate to local control authority and does not introduce dependencies that could impair individual vehicle operation.

During abnormal or emergency conditions, recorded data provides a stable reference that assists in post-event analysis and system improvement. By capturing not only fault states but also preceding conditions and control responses, the subsystem enables comprehensive understanding of system behavior under stress. This understanding supports refinement of future system designs and operating strategies.

The propulsion and energy management architecture supports a plurality of operating modes that allow system behavior to be coordinated with differing operational contexts, performance objectives, and environmental conditions. These operating modes do not alter the fundamental hierarchy of control established in earlier sections. Instead, they provide structured variation in how secondary objectives are pursued while preserving safety, driver intent, and propulsion continuity as overriding constraints.

Operating modes are implemented through parameterization of ECU control logic rather than through structural reconfiguration of the system. Selection of an operating mode influences prioritization, thresholds, and permissible ranges for energy routing, staging, harvesting, and conditioning. The ECU enforces these adjustments dynamically and reversibly, ensuring that transitions between modes do not introduce instability or require interruption of vehicle operation.

In a propulsion-priority operating mode, the ECU emphasizes immediate responsiveness and sustained propulsion availability. In this mode, energy harvesting, staged charging, and external exchange activities are constrained to minimize interference with propulsion performance. Intermediate reservoirs are maintained with sufficient headroom to support rapid transitions and stabilization, and respiration transitions are timed conservatively to preserve continuous propulsion capability. This mode is suited to scenarios involving high driver demand, dynamic maneuvering, or challenging driving conditions.

In an efficiency-oriented operating mode, the ECU places greater emphasis on energy recovery and long-term optimization. Aerodynamic harvesting may be increased under favorable conditions, staged charging of offline propulsion battery packs may proceed more aggressively within safe limits, and external energy exchange may be permitted when appropriate. Even in this mode, safety and driver intent remain dominant, and energy optimization activities are immediately curtailed when higher-priority conditions arise.

In a stationary or low-mobility operating mode, such as when the vehicle is parked or operating at minimal propulsion levels, the ECU may reallocate system priorities toward energy conditioning, external exchange, or reservoir balancing. Propulsion readiness is preserved but may be maintained at a lower immediate threshold if extended stationary operation is anticipated. This mode allows the system to perform maintenance-like functions, such as deep conditioning or extended staging, without affecting drivability.

Operating modes may also reflect environmental or mission-specific contexts. For example, a mode optimized for high-temperature environments may impose stricter thermal limits and reduce reliance on components sensitive to heat. A mode optimized for long-duration operation may emphasize balanced utilization of reservoirs to minimize cumulative stress. These adaptations occur within the same control hierarchy and do not bypass safety constraints.

The ECU manages transitions between operating modes through controlled parameter adjustment rather than abrupt state changes. When a new mode is selected or inferred, the ECU evaluates current system conditions and applies changes incrementally to avoid transient disturbances. If conditions are incompatible with the requested mode, the ECU may defer full activation or maintain partial characteristics until conditions permit.

System-level behavioral coordination ensures that operating modes influence multiple subsystems coherently. For example, a change in mode may simultaneously adjust turbine harvesting behavior, buffer battery utilization, supercapacitor operating windows, and respiration timing. These coordinated adjustments prevent conflicting behaviors that could arise if subsystems responded independently.

Driver interaction with operating modes is abstracted to maintain simplicity. The driver may select high-level preferences or modes through a user interface, but the ECU translates those selections into detailed control behavior internally. In automated or assisted embodiments, operating modes may be selected or adjusted automatically based on detected conditions or mission profiles.

Importantly, operating modes do not introduce rigid partitions in system behavior. The ECU retains the ability to override mode-specific behavior in response to safety-critical events or unexpected conditions. Modes therefore serve as guidance rather than as constraints, allowing the system to remain adaptable and resilient.

Automatic mode inference is supported in embodiments where the ECU is configured to select or adjust operating modes based on observed conditions rather than relying solely on explicit driver selection. In such embodiments, the ECU evaluates factors such as vehicle speed, duration of operation, frequency of acceleration or braking events, thermal margins, and availability of external energy sources. Based on these evaluations, the ECU may infer that a particular operating mode is better suited to current conditions and may transition system behavior accordingly while preserving transparency to the driver.

Automatic mode inference does not supplant driver authority. If the driver explicitly selects a mode or expresses preferences inconsistent with inferred behavior, the ECU treats the driver's input as authoritative within safety constraints. In the absence of explicit driver input, inferred modes allow the system to adapt intelligently to changing contexts without requiring manual intervention.

Interaction between operating modes and external energy participation is coordinated to avoid unintended consequences. In modes emphasizing propulsion readiness or dynamic performance, the ECU restricts or suspends external energy exchange to ensure that internal reserves remain available. In modes oriented toward stationary operation or energy support, the ECU may permit broader participation in external exchange while maintaining defined readiness margins. These adjustments are applied uniformly across external interfaces to maintain consistency and predictability.

The ECU further manages transitions between internally focused modes and externally oriented modes through staged adjustments. For example, when transitioning from a stationary energy-support mode to an active propulsion mode, the ECU gradually disengages external exchange, reestablishes internal staging priorities, and confirms propulsion readiness before enabling full vehicle operation. This sequencing prevents abrupt changes that could compromise stability or safety.

Over longer operational horizons, the ECU may refine mode behavior based on accumulated experience. By observing how the system responds to different modes under varying conditions, the ECU may adjust thresholds or prioritization weights within predefined bounds. Such refinement improves effectiveness without altering the fundamental structure or intent of each mode. Importantly, refinement remains bounded and does not create new modes or behaviors beyond those contemplated by the architecture.

The ECU may also incorporate environmental or usage pattern recognition into mode coordination. Repeated exposure to similar conditions, such as extended highway travel or frequent stationary energy use, may inform subtle adjustments in how modes are applied. These adjustments enhance alignment between system behavior and real-world usage without requiring explicit configuration.

In all cases, operating modes remain subordinate to safety systems and fault handling logic. If conditions arise that require protective action, mode-specific behavior is immediately overridden. Modes therefore guide normal operation but do not constrain emergency response or recovery.

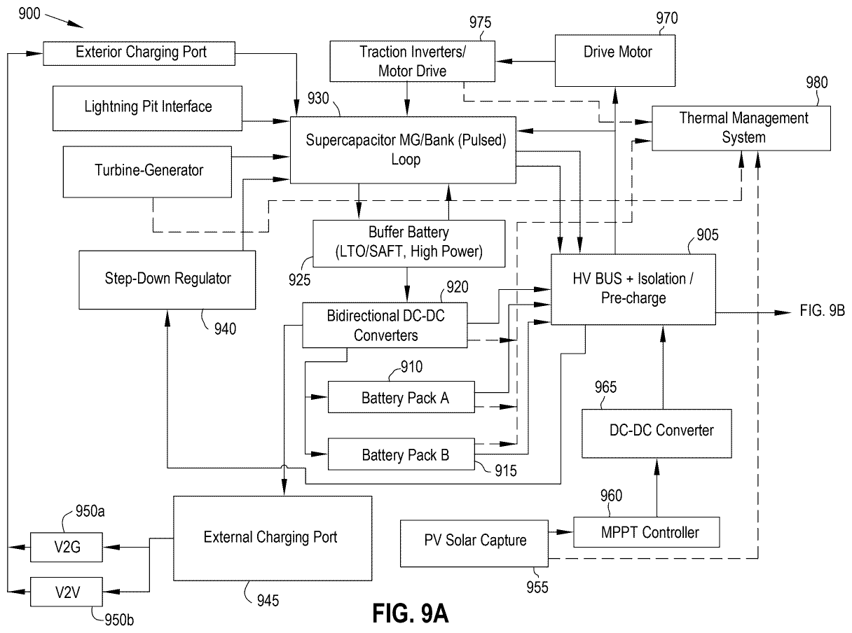

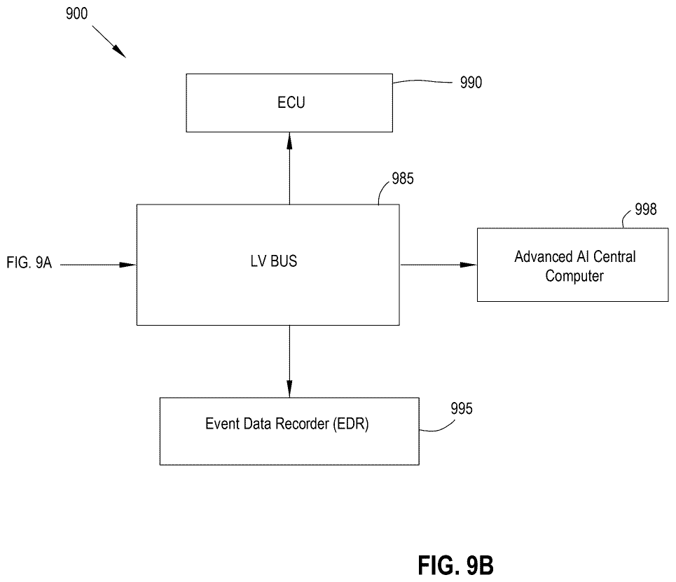

FIGS. 9A and 9B illustrate a comprehensive propulsion and energy management architecture 900 incorporating multiple energy sources, intermediate energy handling elements, and controlled distribution across high-voltage and low-voltage domains. The architecture 900 includes a high-voltage bus with isolation and pre-charge circuitry 905 operating within a nominal voltage range of approximately 900-1100 volts, which serves as a central electrical coupling point for propulsion, energy storage, and energy conversion subsystems.

Electrical energy is delivered to the high-voltage bus 905 from a plurality of energy sources. A first propulsion battery pack 910 and a second propulsion battery pack 915 are electrically coupled to the high-voltage bus 905 through bidirectional DC-DC converters 920, enabling controlled charging and discharging of the battery packs. A buffer battery 925, implemented as a high-power battery such as an LTO or SAFT-type battery, is also coupled to the high-voltage bus 905 and provides intermediate energy storage for high-power transient handling.

A supercapacitor motor-generator bank loop 930 is coupled to the high-voltage bus 905 and includes a supercapacitor bank configured to operate in a pulsed mode. The supercapacitor motor-generator bank loop 930 includes rectifier and boost circuitry positioned after a motor-generator stage, enabling conversion of pulsed mechanical or electrical energy into conditioned electrical energy prior to coupling with the high-voltage bus 905.

A turbine generator subsystem 935 is provided as an auxiliary energy harvesting source and includes a turbine generator with rectifier and boost circuitry. Electrical output from the turbine generator subsystem 935 is supplied to a step-down DC-DC regulator 940 configured for capacitor or generator interfacing, and is subsequently routed into the supercapacitor motor-generator bank loop 930 or the high-voltage bus 905 under controlled conditions.

An exterior charging port 945 provides an interface for external energy input, including lightning pit interfaces capable of delivering high-power pulses on the order of 15-20 MW. The exterior charging port 945 is electrically coupled through controlled conversion stages into the architecture 900, enabling external energy to be introduced into the high-voltage domain in a managed manner.

A photovoltaic solar capture subsystem 955 is optionally included and comprises photovoltaic conversion elements electrically coupled to a maximum power point tracking controller 960. Output from the MPPT controller 960 is supplied to a DC-DC converter 965 configured to couple photovoltaic energy into the high-voltage bus 905. In this manner, photovoltaic energy is introduced into the same controlled energy routing architecture as other harvested or stored energy sources.

Electrical energy from the high-voltage bus 905 is supplied to the drive motor 970, which provides mechanical propulsion to the vehicle. Mechanical energy from the drive motor 970 may also be recaptured via one or more inverters and/or drive generators 975. Thermal conditions associated with propulsion, energy storage, and conversion are managed by a thermal management system 980, which exchanges control and status signals with the high-voltage bus 905 and associated subsystems.

A DC-DC converter 980 is coupled between the high-voltage bus 905 and a low-voltage bus 985 operating at approximately 12-14 volts. The low-voltage bus 985 supplies power to auxiliary systems including electronic control units, shutters, feathering actuators, pumps, fans, lighting, and telemetry components.

Control and supervisory functions are provided by an advanced central computer 990, which may implement artificial intelligence-based control logic and is coupled to an event data recorder or black box 995. The central computer 990 and event data recorder 995 together form an ECU and power management subsystem 998 configured to coordinate energy routing, propulsion control, safety functions, and system diagnostics across the architecture 900.

As illustrated in FIG. 9, the architecture 900 integrates propulsion batteries, auxiliary harvesting sources, intermediate energy storage elements, and controlled power electronics into a unified system in which electrical energy is selectively routed, conditioned, and distributed across multiple voltage domains under centralized control.

The propulsion and energy management system described herein admits of numerous variations and alternative implementations without departing from the core architectural principles disclosed above. The embodiments described in preceding sections are illustrative of functional relationships among energy reservoirs, conversion subsystems, and centralized control logic, and are not intended to limit the scope of the system to any particular configuration, component selection, or operating sequence.

In certain embodiments, the number, capacity, or type of propulsion battery packs may vary according to vehicle class or application. For example, a system may employ two propulsion battery packs operating in alternating respiration cycles, while other embodiments may employ three or more packs to further distribute duty cycles or enhance redundancy. The control logic governing respiration, isolation, and staged charging remains applicable regardless of the number of propulsion packs present, provided that each pack is subject to ECU-controlled authorization and isolation.

Similarly, the composition and sizing of intermediate energy reservoirs may vary. Some embodiments may employ a buffer battery optimized for moderate-rate energy accumulation and delivery, while others may emphasize supercapacitor capacity for handling higher transient power. In certain implementations, one type of intermediate reservoir may be omitted or reduced if system objectives can be satisfied through alternative staging mechanisms. These variations affect performance characteristics but do not alter the underlying staged energy handling model.

The motor-generator subsystem may likewise be implemented in different forms. In some embodiments, a single motor-generator unit provides pulse-conditioned energy transfer to offline propulsion battery packs. In other embodiments, multiple motor-generator units may be employed in parallel or in dedicated roles, such as separating conditioning of harvested energy from conditioning of externally supplied energy. The electromechanical nature of the subsystem and its role as an energy-conditioning intermediary remain consistent across such variations.

Aerodynamic energy harvesting may be implemented using different turbine geometries, airflow paths, or integration strategies depending on vehicle design constraints. In some embodiments, turbine generators may be retractable or selectively exposed to airflow, while in others they may be integrated into fixed ducts with variable geometry. In all cases, turbine operation remains under ECU control and is subordinated to propulsion efficiency, safety, and driver intent.

External electrical interfaces may also vary in number, form factor, and supported protocols. Some embodiments may include multiple interfaces dedicated to different types of external interaction, such as charging, energy export, or vehicle-to-vehicle support. Other embodiments may consolidate external interaction through a single interface capable of bidirectional operation. Regardless of interface implementation, external energy exchange is governed by the same routing, staging, and isolation principles described herein.

Control logic may be distributed across multiple processing units or integrated into a single ECU, depending on system architecture and redundancy requirements. In distributed embodiments, coordination among control units preserves the hierarchical control structure and centralized authorization model. Safety, driver intent, and energy management priorities remain enforced consistently, even when computational responsibilities are partitioned.

Operating modes described above may be expanded, refined, or combined to suit particular applications. Additional modes may be defined for specialized environments or mission profiles, provided that such modes operate within the established control hierarchy and do not bypass safety or isolation constraints. Mode selection may be manual, automatic, or hybrid, without altering fundamental system behavior.

In certain embodiments, additional energy harvesting mechanisms may be integrated into the system, such as photovoltaic panels or waste-heat recovery devices. These mechanisms may be treated as additional conditional energy sources and integrated into the routing network under ECU control. The presence of such mechanisms does not alter the system's adherence to energy conservation principles or its non-perpetual operation.

It is further contemplated that individual subsystems described herein may be implemented using different technologies or components as those technologies evolve. Advances in battery chemistry, power electronics, or control hardware may be incorporated into the architecture without altering its conceptual framework. The system's modular and scalable design facilitates such evolution while preserving compatibility with existing control logic.

In the foregoing description, it will be readily appreciated by those skilled in the art that modifications may be made to the invention without departing from the concepts disclosed herein. Such modifications are to be considered as included in the following claims, unless the claims by their language expressly state otherwise.

Variations described for exemplary embodiments of the present invention can be realized in any combination desirable for each particular application. Thus, particular limitations, and/or embodiment enhancements described herein, which may have particular limitations, need be implemented in methods, systems, and/or apparatuses including one or more concepts describe with relation to exemplary embodiments of the present invention.

Therefore, it is intended that the invention not be limited to the particular embodiments disclosed as the best mode contemplated for carrying out this invention, but that the invention will include all embodiments falling within the scope of the present application as set forth in the following claims, wherein reference to an element in the singular, such as by use of the article “a” or “an” is not intended to mean “one and only one” unless specifically so stated, but rather “one or more.” Moreover, no claim element is to be construed under the provisions of 35 U.S.C. § 112, sixth paragraph, unless the element is expressly recited using the phrase “means for” or “step for.” These following claims should be construed to maintain the proper protection for the present invention.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, where this document refers to technologies that would be apparent or known to one of ordinary skill in the art, such technologies encompass those apparent or known to the skilled artisan now or at any time in the future. Furthermore, the use of plurals can also refer to the singular, including without limitation when a term refers to one or more of a particular item; likewise, the use of a singular term can also include the plural, unless the context dictates otherwise.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

There has thus been outlined, rather broadly, the more important features of the disclosure in order that the detailed description thereof may be better understood, and in order that the present contribution to the art may be better appreciated. There are additional features of the disclosure that will be described hereinafter, and which will also form the subject matter of the claims appended hereto. The features listed herein, and other features, aspects and advantages of the present disclosure will become better understood with reference to the following description and appended claims.

While various embodiments of the present disclosure have been described above, it should be understood that they have been presented by way of example only, and not of limitation. Likewise, the various diagrams may depict an example architectural or other configuration for the invention, which is provided to aid in understanding the features and functionality that can be included in the invention. The invention is not restricted to the illustrated example architectures or configurations, but the desired features can be implemented using a variety of alternative architectures and configurations.

Indeed, it will be apparent to one of skill in the art how alternative functional configurations can be implemented to implement the desired features of the present disclosure. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present invention should not be limited by any of the above-described exemplary embodiments.

What is claimed is:

1. A vehicle propulsion and energy management system, comprising:
a plurality of electrical energy storage devices including at least a first propulsion battery and a second propulsion battery;
a drive motor configured to deliver propulsion torque to a drivetrain of a vehicle;
power conversion circuitry electrically coupled between the plurality of electrical energy storage devices and the drive motor; and
a control system configured to selectively assign propulsion duty to one of the first propulsion battery and the second propulsion battery while the other of the first propulsion battery and the second propulsion battery is placed in a non-propulsion role,
wherein the control system is further configured to route electrical energy between the plurality of electrical energy storage devices through one or more intermediate energy transfer paths to condition energy delivery independently of propulsion demand.

2. The system of claim 1, wherein the non-propulsion role comprises at least one of charging, balancing, thermal recovery, or rest.

3. The system of claim 1, wherein the control system is configured to alternate propulsion duty between the first propulsion battery and the second propulsion battery during vehicle operation.

4. The system of claim 1, further comprising an intermediate energy storage device electrically coupled between the plurality of electrical energy storage devices and the drive motor.

5. The system of claim 4, wherein the intermediate energy storage device comprises a supercapacitor bank.

6. The system of claim 5, wherein the control system is configured to route regenerative braking energy preferentially to the supercapacitor bank before transferring energy from the supercapacitor bank to one of the plurality of electrical energy storage devices.

7. The system of claim 1, further comprising an energy conversion chain including:
a pulsing battery configured to deliver electrical energy in a pulsed manner;
a motor configured to convert pulsed electrical energy into mechanical rotational energy;
a generator mechanically coupled to the motor to convert mechanical rotational energy into electrical energy; and
a voltage conditioning circuit configured to condition electrical output from the generator prior to storage or further use.

8. The system of claim 7, wherein the voltage conditioning circuit is coupled to a charge control unit configured to regulate acceptance of conditioned electrical energy.

9. The system of claim 1, further comprising a wind energy harvesting subsystem including:
a wind input;
turbine fins configured to convert kinetic energy of airflow into mechanical energy;
a generator mechanically coupled to the turbine fins; and
a charge control unit configured to regulate electrical energy produced by the generator.

10. The system of claim 9, further comprising a boost converter disposed between the generator and the charge control unit.

11. The system of claim 1, further comprising a photovoltaic energy harvesting subsystem configured to generate electrical energy from incident light.

12. The system of claim 11, wherein the photovoltaic energy harvesting subsystem includes one or more photovoltaic panels mounted on an exterior surface of the vehicle.

13. The system of claim 11, further comprising a charge control unit electrically coupled between the photovoltaic energy harvesting subsystem and at least one of the plurality of electrical energy storage devices.

14. The system of claim 13, wherein the charge control unit is configured to regulate voltage or current of electrical energy generated by the photovoltaic energy harvesting subsystem prior to delivery to the plurality of electrical energy storage devices.

15. The system of claim 11, wherein electrical energy generated by the photovoltaic energy harvesting subsystem is routed independently of propulsion power delivery.

16. The system of claim 11, wherein the control system is configured to selectively accept or inhibit electrical energy generated by the photovoltaic energy harvesting subsystem based on a system operating condition.

17. The system of claim 1, wherein the control system is configured to inhibit energy routing operations in response to a safety-critical condition.

18. The system of claim 17, wherein the safety-critical condition comprises at least one of braking input, traction control intervention, or stability control intervention.

19. A method of managing electrical energy in a vehicle, comprising:
selectively assigning propulsion duty to a first propulsion battery while placing a second propulsion battery in a non-propulsion role;
delivering electrical energy from the first propulsion battery to a drive motor to propel the vehicle;
routing electrical energy through an intermediate energy transfer path independent of propulsion demand; and
reassigning propulsion duty between the first propulsion battery and the second propulsion battery during vehicle operation.

20. The method of claim 19, further comprising routing regenerative braking energy to an intermediate energy storage device prior to charging one of the first propulsion battery and the second propulsion battery.

21. The method of claim 19, further comprising converting pulsed electrical energy to mechanical energy and reconverting the mechanical energy to conditioned electrical energy prior to storage.

22. The method of claim 19, further comprising harvesting wind energy using turbine fins and converting the harvested energy to conditioned electrical energy for storage.

23. The method of claim 19, further comprising harvesting photovoltaic energy from incident light and converting the harvested energy to conditioned electrical energy for storage.

24. The method of claim 19, further comprising inhibiting energy routing in response to detection of a safety-critical condition.
